(19) United States
(12) Patent Application Publication
(10) Pub. No.: US 2022/0038354 A1
(43) Pub. Date: Feb. 3, 2022

(54) GENERATION METHOD AND GENERATION PROGRAM

(71) Applicant: FUJITSU LIMITED, Kawasaki-shi (JP)

(72) Inventor: Masahiro Asaoka, Kawasaki (JP)

(73) Assignee: FUJITSU LIMITED, Kawasaki-shi (JP)

(21) Appl. No.: 17/347,305

(22) Filed: Jun. 14, 2021

(30) Foreign Application Priority Data
Aug. 3, 2020 (JP) 2020-132000

(51) Int. Cl. H04L 12/26; H04L 29/08

(52) U.S. Cl. CPC H04L 43/065; H04L 67/34; H04L 43/0817; H04L 43/067

(57) ABSTRACT

A generation method for a computer to execute a process includes acquiring performance information of a container, which has been implemented in a first node and has been using a first network interface owned by the first node, after the container is moved to a second node different from the first node; specifying performance information of a second network interface, which represents a feature similar to a feature represented by the acquired performance information of the container after being moved, among performance information of a network interface owned by the second node; and generating correspondence information that associates performance information of the first network interface with the specified performance information of the second network interface.

### CROSS-REFERENCE TO RELATED APPLICATION

This application is based upon and claims the benefit of priority of the prior Japanese Patent Application No. 2020-132000, filed on Aug. 3, 2020, the entire contents of which are incorporated herein by reference.

### FIELD

The embodiment discussed herein is related to a generation method and a generation program.

### BACKGROUND

Conventionally, there is a virtual environment called a container, which is an execution space for executing a process in an isolated special state. The special state means a state in which a process is given a unique process ID (PID) in the execution space. Here, there are demands to collect, monitor, or predict information indicating performance of a container or a network interface (NI) used by the container.

Prior art includes, for example, one dividing a plurality of resources into a plurality of resource groups and analyzing performance data for every divided resource group based on the correlation of changes in performance data between resources. Furthermore, for example, there is a technology to estimate performance information of a migration target virtual machine in a migration destination server device by applying a combination of a workload amount and a workload characteristic value converted from performance information of the migration target virtual machine to a performance model of the migration destination server device.

Japanese Laid-open Patent Publication No. 2019-191929 and International Publication Pamphlet No. WO 2013/132735 are disclosed as related art.

### SUMMARY

According to an aspect of the embodiments, a generation method for a computer to execute a process includes acquiring performance information of a container, which has been implemented in a first node and has been using a first network interface owned by the first node, after the container is moved to a second node different from the first node; specifying performance information of a second network interface, which represents a feature similar to a feature represented by the acquired performance information of the container after being moved, among performance information of a network interface owned by the second node; and generating correspondence information that associates performance information of the first network interface with the specified performance information of the second network interface.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a generation method according to an embodiment;

FIG. 2 is an explanatory diagram illustrating an example of a container execution system 200;

FIG. 3 is a block diagram illustrating a hardware configuration example of a generation device 100;

FIG. 4 is an explanatory diagram illustrating an example of content stored in a property information management table 400;

FIG. 5 is an explanatory diagram illustrating an example of content stored in a metrics information management table 500;

FIG. 6 is an explanatory diagram illustrating an example of content stored in a node-Pod connection information management table 600;

FIG. 7 is an explanatory diagram illustrating an example of content stored in a node-NI connection information management table 700;

FIG. 8 is an explanatory diagram illustrating an example of content stored in a Pod-container connection information management table 800;

FIG. 9 is an explanatory diagram illustrating an example of content stored in a container-NI connection information management table 900;

FIG. 10 is an explanatory diagram illustrating an example of content stored in a pre-movement property information management table 1000;

FIG. 11 is an explanatory diagram illustrating an example of content stored in a post-movement property information management table 1100;

FIG. 12 is an explanatory diagram illustrating an example of content stored in a post-combination metrics information management table 1200;

FIG. 13 is a block diagram illustrating a functional configuration example of the generation device 100;

FIG. 14 is a block diagram illustrating a specific functional configuration example of the generation device 100;

FIG. 15 is an explanatory diagram illustrating a flow of operation of the generation device 100;

FIG. 16 is an explanatory diagram (No. 1) illustrating operation example 1 of the generation device 100;

FIG. 17 is an explanatory diagram (No. 2) illustrating operation example 1 of the generation device 100;

FIG. 18 is an explanatory diagram (No. 3) illustrating operation example 1 of the generation device 100;

FIG. 19 is an explanatory diagram (No. 4) illustrating operation example 1 of the generation device 100;

FIG. 20 is an explanatory diagram (No. 5) illustrating operation example 1 of the generation device 100;

FIG. 21 is an explanatory diagram (No. 6) illustrating operation example 1 of the generation device 100;

FIG. 22 is a flowchart (No. 1) illustrating an example of an overall processing procedure in operation example 1;

FIG. 23 is a flowchart (No. 2) illustrating an example of an overall processing procedure in operation example 1;

FIG. 24 is an explanatory diagram (No. 1) illustrating operation example 2 of the generation device 100;

FIG. 25 is an explanatory diagram (No. 2) illustrating operation example 2 of the generation device 100;

FIG. 26 is an explanatory diagram (No. 3) illustrating operation example 2 of the generation device 100;

FIG. 27 is an explanatory diagram (No. 4) illustrating operation example 2 of the generation device 100;

FIG. 28 is a flowchart (No. 1) illustrating an example of an overall processing procedure in operation example 2;

FIG. 29 is a flowchart (No. 2) illustrating an example of an overall processing procedure in operation example 2; and

FIG. 30 is a flowchart (No. 3) illustrating an example of an overall processing procedure in operation example 2.

### DESCRIPTION OF EMBODIMENTS

In the prior art, when a container has moved between nodes, there is a problem that it is not possible to associate information indicating performance of NI used by the container before being moved with information indicating performance of NI used by the container after being moved. Thus, upon monitoring the information indicating the performance of NI used by the container after being moved, it is not possible to divert a threshold or the like used when monitoring the information indicating the performance of NI that is used by the container before being moved, and appropriate monitoring may fail. Furthermore, upon predicting the information indicating the performance of NI used by the container after being moved, it is not possible to refer to the information indicating the performance of NI used by the container before being moved, which leads to a decrease in prediction accuracy.

In one aspect, it is an object of the embodiment to associate information indicating performance of NI used by a container before being moved with information indicating performance of NI used by the container after being moved.

Hereinafter, an embodiment of a generation method and a generation program will be described in detail with reference to the drawings.

(Example of Generation Method According to Embodiment)

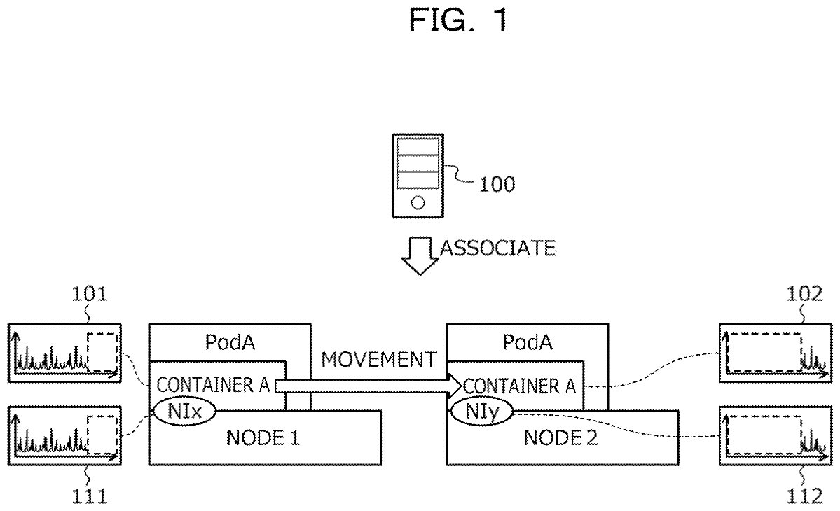

FIG. 1 is an explanatory diagram illustrating an example of a generation method according to an embodiment. A generation device 100 is a computer for facilitating use of performance information of a network interface owned by a node. In the following description, the network interface may be referred to as “NI”.

The performance information is, for example, time-series information indicating a time change in performance value of NI. For example, there are demands to collect, monitor, or predict performance information of NI. For example, there is a demand to collect performance information of NI, monitor the performance information of NI, and output an alert when the performance value of NI meets a predetermined condition. Furthermore, for example, there is a demand to collect performance information of NI and predict future changes in the performance value of NI.

However, when a container moves between nodes, there is a problem that the performance information of NI used by the container is disconnected before and after movement. In other words, there is a problem that it is not possible to associate the performance information of NI used by the container before being moved with the performance information of NI used by the container after being moved.

For example, movement means deleting a first container that is running on one node and starting a new second container with the same contents as the first container on another node, and the first container and the second container will be treated as separate containers. Thus, when the container moves between nodes, the performance information of NI used by the container will be disconnected before and after movement.

In particular, if there are multiple containers that are moved, started, or deleted in the same period, it is difficult to associate the performance information of NI used by the container before being moved with the performance information of NI used by the container after being moved.

Thus, upon monitoring the performance information of NI used by the container after being moved, it is not possible to use a threshold or the like used when monitoring the performance information of NI used by the container before being moved, and appropriate monitoring may fail. Furthermore, upon predicting the performance information of NI used by the container after being moved, it is not possible to refer to the performance information of NI used by the container before being moved, which leads to decrease in accuracy of the prediction.

Here, it is conceivable that properties of each NI before and after movement of the container are collected, and the performance information of NI used by the container before being moved is associated with the performance information of NI used by the container after being moved. However, the properties of NI used by the container before being moved and the properties of NI used by the container after being moved do not contain common elements. Thus, it is not possible to associate the performance information of NI used by the container before being moved with the performance information of NI used by the container after being moved.

Furthermore, it is conceivable to collect, every time the container is moved, information indicating the connection relationship between the container and NI from each node, so as to associate the performance information of NI used by the container before being moved and the performance information of NI used by the container after being moved based on the collected information. However, when collecting information indicating the connection relationship between the container and NI, there is a problem that the processing load on each node increases.

Accordingly, the present embodiment describes a generation method that may associate information indicating performance of NI used by the container before being moved and information indicating performance of NI used by the container after being moved, without referring to information that directly indicates the connection relationship between the container after being moved and NI.

In the example of FIG. 1, a node 1 and a node 2 are present. The generation device 100 is capable of communicating with the node 1 and the node 2.

The node 1 has one or more NIs, including at least NIx. The node 1 has created and started a Pod A including a container A in the past. The container A has been using NIx. The node 1 deletes the Pod A including the container A that has been running on the node 1 in order to move the Pod A including the container A from the node 1 to the node 2.

The node 2 has one or more NIs, Including at least NIy. In order to move the Pod A including the container A from the node 1 to the node 2, the node 2 creates and starts a new Pod A including the container A when the Pod A including the container A started on the node 1 is deleted. The container A after movement uses NIy.

In the example of FIG. 1, because the Pod A including the container A is moved from the node 1 to the node 2, performance information 101 of the container A before movement and performance information 102 of the container A after movement are disconnected. Disconnection means that a plurality of pieces of performance information related to the same container is not associated with each other. Furthermore, performance information 111 of NIx that has been used by the container A before movement and performance information 112 of NIy used by the container A after movement are disconnected.

(1-1) The generation device 100 acquires the performance information 102 of the container A after movement. The generation device 100 acquires, for example, the performance information 102 of the container A after movement by reception from the node 2.

(1-2) The generation device 100 specifies performance information 112 of NIy, which represents a feature similar to the feature represented by the acquired performance information 102 of the container A after movement, among the performance information of NI owned by the node 2. The feature is represented by, for example, a distribution at a time point when the performance value changes by a certain amount or more.

(1-3) The generation device 100 generates correspondence information that associates the performance information 111 of NIx with the specified performance information 112 of NIy. The correspondence information is, for example, combined information obtained by combining a time series of performance values of the specified performance information 112 of NIy to a rear of a time series of performance values indicated by the performance information 111 of NIx. The generation device 100 outputs generated correspondence information. The generation device 100 outputs, for example, the generated correspondence information so that the user can refer to it.

Thus, the generation device 100 may associate a plurality of pieces of performance information regarding the same container that has been disconnected. Even if there are multiple containers that are moved, started, or deleted in the same period, the generation device 100 may associate the performance information of NI used by the container before being moved and the performance information of NI used by the container after being moved with each other.

At this time, the generation device 100 may avoid collecting information indicating the connection relationship between the container and NI from each node every time the container is moved, and may suppress increase in processing load on each node. Furthermore, the generation device 100 may avoid collecting information indicating the connection relationship between the container and NI from each node every time the container is moved, and may suppress increase in network traffic by communicating with each node.

Thus, the generation device 100 may facilitate use of the performance information of NI that has been used by the container before and after movement. The generation device 100 may facilitate acquisition of, for example, a set value such as a threshold associated with the performance information of NI used by the container before being moved, which has been used when monitoring the performance information of NI used by the container before being moved. Then, for example, the generation device 100 may divert the acquired set value upon monitoring the performance information of NI used by the container after being moved, and may facilitate appropriate monitoring.

Furthermore, for example, upon predicting future changes in performance value of NI used by the container after being moved, the generation device 100 may refer to performance information of NI used by the container before being moved, in addition to performance information of NI used by the container after being moved. Thus, the generation device 100 may suppress decrease in accuracy of predicting changes in future performance value of NI used by the container after being moved. Furthermore, the generation device 100 may allow the user to refer to the performance information of NI used by the container before being moved and the performance information of NI used by the container after being moved.

Here, the case where the correspondence information is combined information obtained by combining the time series of performance values of the specified performance information 112 of NIy to a rear of the time series of performance values indicated by the performance information 111 of NIx have been described, but the embodiment is not limited thereto. For example, there may be cases where the correspondence information is information in which identification information that identifies NIx and identification information that identifies NIy are associated with each other, and is information in which the performance information 111 of NIx and the performance information 112 of NIy are indirectly associated with each other.

Here, the case where the generation device 100 does not associate the performance information 101 of the container A before movement with the performance information 102 of the container A after movement has been described, but the embodiment is not limited thereto. For example, there may be cases where, based on a result of comparison of the property of the container A before movement with the property of the container A after movement, the generation device 100 associates the performance information 101 of the container A before movement with the performance information 102 of the container A after movement.

(Example of Container Execution System 200)

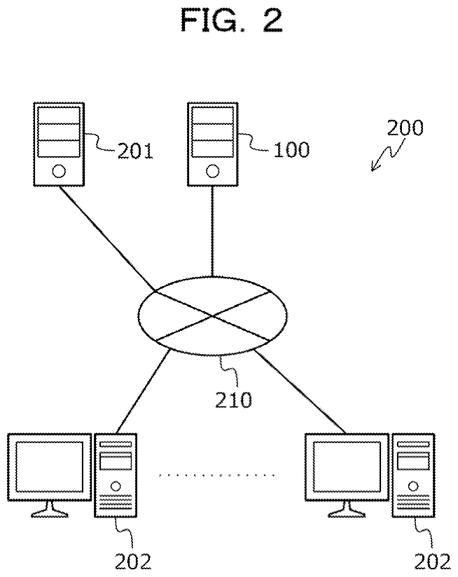

Next, an example of a container execution system 200 to which the generation device 100 illustrated in FIG. 1 is applied will be described with reference to FIG. 2.

FIG. 2 is an explanatory diagram illustrating an example of the container execution system 200. In FIG. 2, the container execution system 200 includes a generation device 100, a movement management device 201, and a plurality of node devices 202.

In the container execution system 200, the generation device 100 and the node device 202 are connected via a wired or wireless network 210. The network 210 is, for example, a local area network (LAN), a wide area network (WAN), the Internet, or the like. Furthermore, the movement management device 201 and the node devices 202 are connected via a wired or wireless network 210.

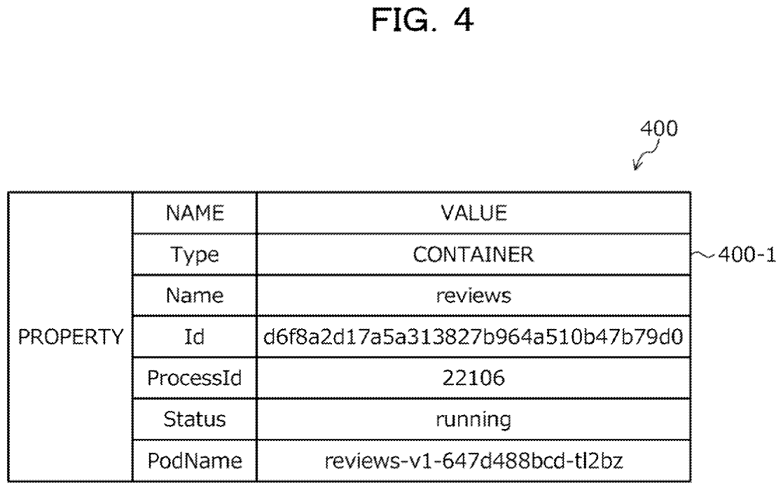

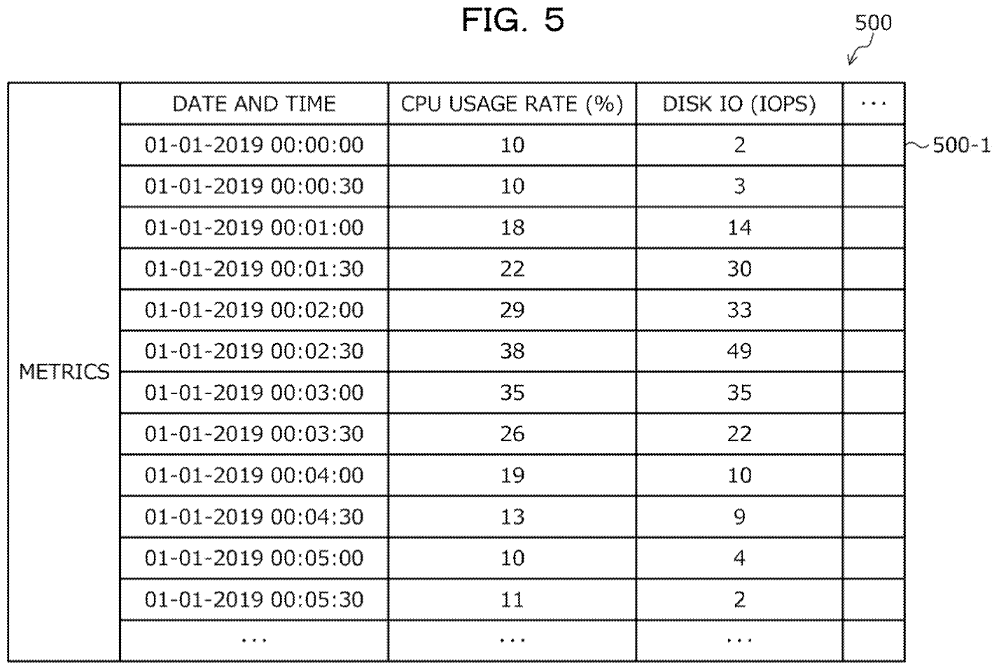

The generation device 100 has various tables described later in FIGS. 4 to 12. The generation device 100 periodically collects property information of a container and property information of NI from each node device 202. The property information of the container and the property information of NI are each stored in, for example, a property information management table 400 described later in FIG. 4. The generation device 100 periodically collects performance information of a container and performance information of NI from each node device 202. The performance information of the container and the performance information of NI are stored in, for example, a metrics information management table 500 described later in FIG. 5.

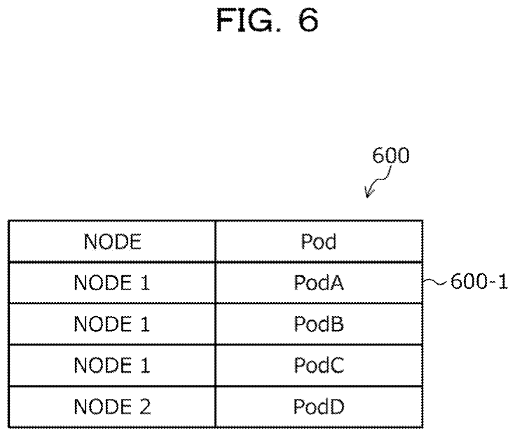

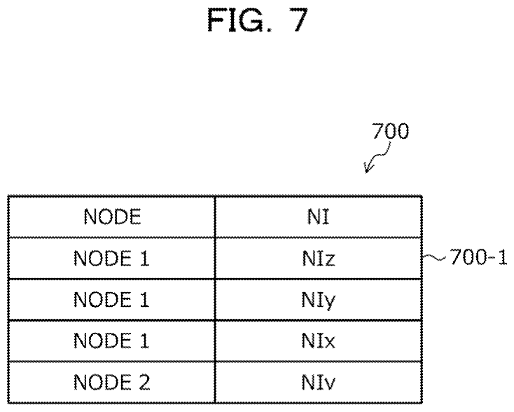

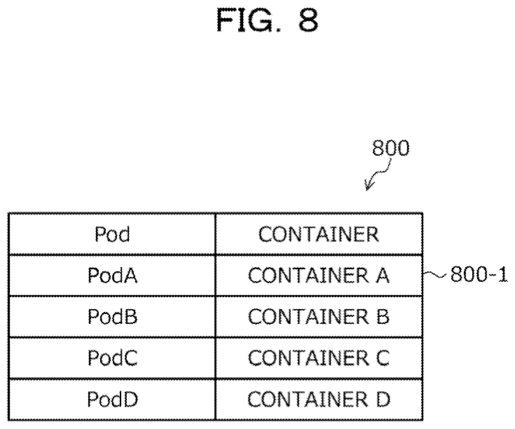

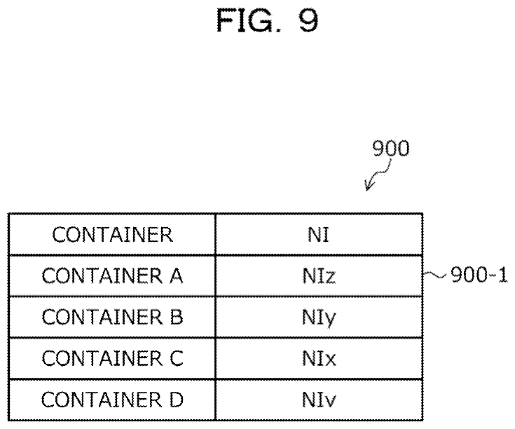

The generation device 100 periodically collects connection information between a node and a Pod, connection information between the node and NI, connection information between the Pod and a container, and connection information between the container and NI from each of the node devices 202. The connection information between the node and the Pod is stored in, for example, a node-Pod connection information management table 600 described later in FIG. 6. The connection information between the node and NI is stored in, for example, a node-NI connection information management table 700, which will be described later in FIG. 7. The connection information between the Pod and the container is stored in, for example, the Pod-container connection information management table 800 described later in FIG. 8. The connection information between the container and NI is stored in, for example, a container-NI connection information management table 900, which will be described later in FIG. 9.

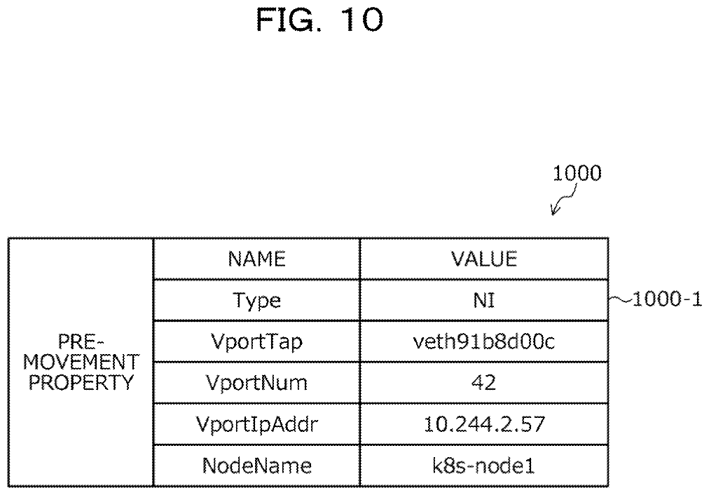

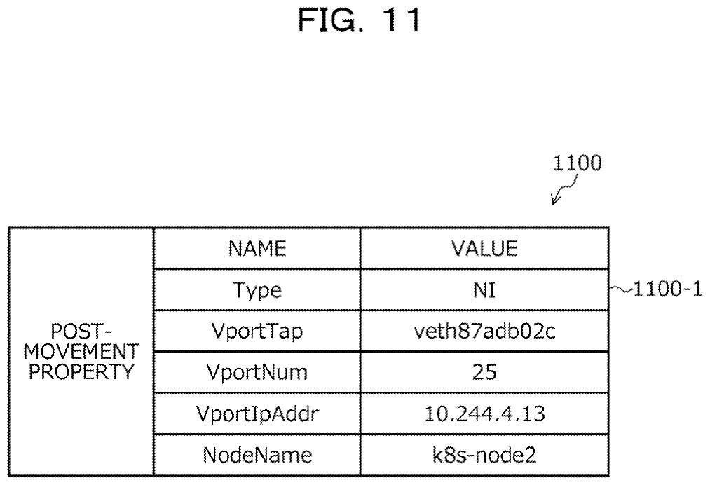

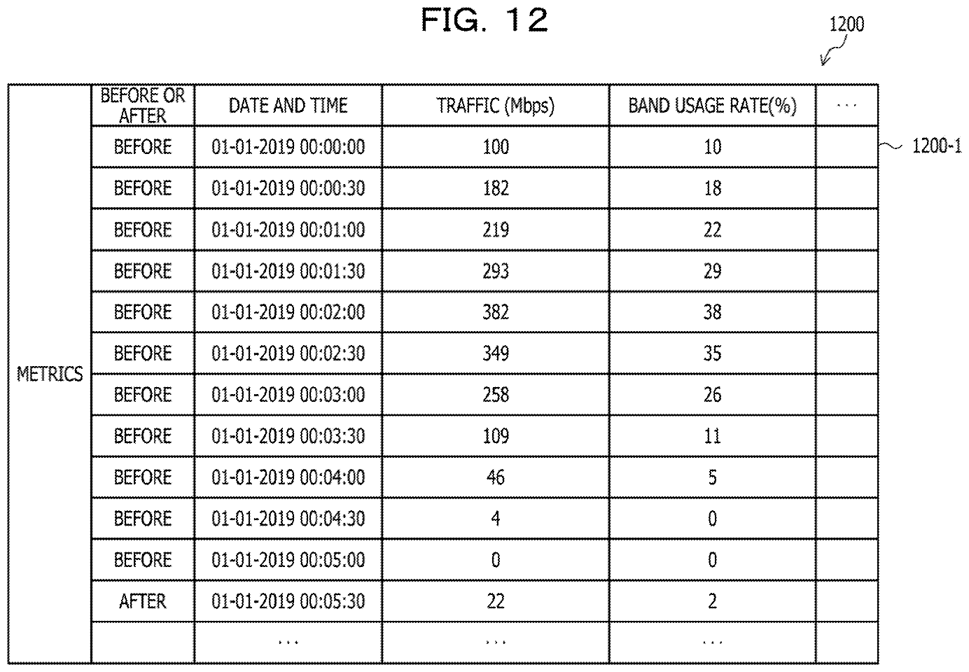

When the container is moved between node devices 202, the generation device 100 generates correspondence information that associates the performance information of NI that has been used by the container before being moved and the performance information of NI being used by the container after being moved based on various collected information. The property information of NI that has been used by the container before being moved is stored in, for example, a pre-movement property information management table 1000, which will be described later in FIG. 10. The property information of NI being used by the container after being moved is stored in, for example, a post-movement property information management table 1100, which will be described later in FIG. 11. The generated correspondence information is stored in the post-combination metrics information management table 1200, which will be described later in FIG. 12, for example. The generation device 100 outputs generated correspondence information. The generation device 100 is, for example, a server, a personal computer (PC), or the like.

The movement management device 201 is a computer that causes the node device 202 to start or delete a container. The movement management device 201 causes the node device 202 to delete the first container, and causes another node device 202 to start a second container having the same contents as the first container, thereby effectively moving the containers between the node devices 202. The movement management device 201 is, for example, a server, a PC, or the like.

The node device 202 is a computer with one or more NIs. The node device 202 starts or deletes a container under control of the movement management device 201. The node device 202 transmits performance information of the container to the generation device 100. The node device 202 transmits performance information of NI to the generation device 100. The node device 202 transmits connection information between the container and NI to the generation device 100. The node device 202 is, for example, a server, a PC, or the like.

Here, the case where the generation device 100 and the movement management device 201 are different devices has been described, but the present embodiment is not limited thereto. For example, the generation device 100 may further have a function as the movement management device 201. In this case, for example, the container execution system 200 does not have to include the movement management device 201.

Furthermore, here, the case where the generation device 100 and the node device 202 are different devices has been described, but the present embodiment is not limited to this. For example, the generation device 100 may further have a function as a node device 202. Furthermore, here, the case where the movement management device 201 and the node device 202 are different devices has been described, but the present embodiment is not limited to this. For example, the movement management device 201 may further have a function as a node device 202.

Here, the case where the generation device 100 collects the performance information of the container, the performance information of NI, and the connection information between the container and NI from each node device 202 has been described, but the embodiment is not limited to this. For example, there may be cases where the generation device 100 receives the performance information of the container, the performance information of NI, and the connection information between the container and NI from the movement management device 201. In this case, the movement management device 201 collects the performance information of the container, the performance information of NI, and the connection information between the container and NI from each node device 202. The movement management device 201 may generate the connection information between the container and NI in its own device based on history of starting or deleting the container in each node device 202.

(Hardware Configuration Example of Generation Device 100)

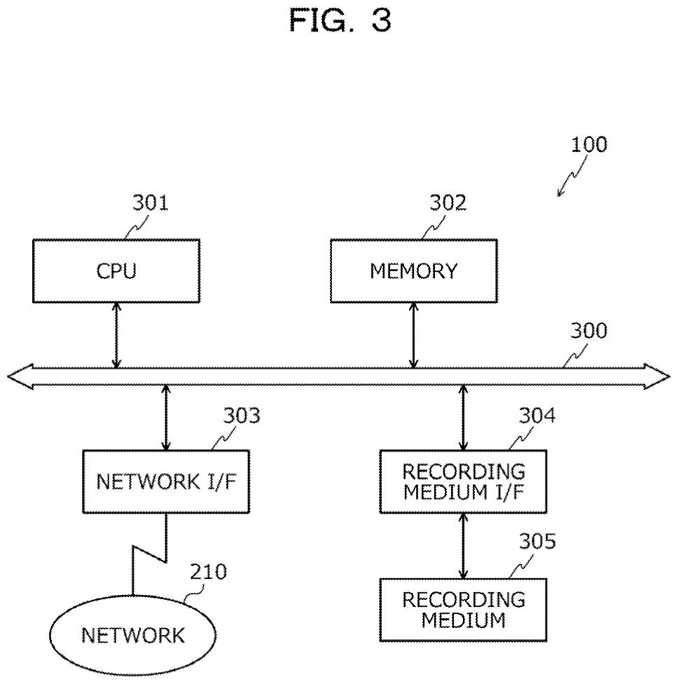

Next, a hardware configuration example of the generation device 100 will be described with reference to FIG. 3.

FIG. 3 is a block diagram illustrating a hardware configuration example of the generation device 100. In FIG. 3, the generation device 100 includes a central processing unit (CPU) 301, a memory 302, a network interface (I/F) 303, a recording medium I/F 304, and a recording medium 305. Furthermore, each of these components is individually connected by a bus 300.

Here, the CPU 301 performs overall control of the generation device 100. The memory 302 includes, for example, a read only memory (ROM), a random access memory (RAM), a flash ROM, and the like. For example, the flash ROM or the ROM stores various programs, and for example, the RAM is used as a work area for the CPU 301. The programs stored in the memory 302 are loaded into the CPU 301 to cause the CPU 301 to execute coded processing.

The network I/F 303 is connected to the network 210 through a communication line, and is connected to another computer through the network 210. Then, the network I/F 303 manages an interface between the network 210 and an inside, and controls input and output of data to and from another computer. Examples of the network I/F 303 include a modem, a LAN adapter, and the like.

The recording medium I/F 304 controls read and write of data to and from the recording medium 305 under the control of the CPU 301. The recording medium I/F 304 is, for example, a disk drive, a solid state drive (SSD), a universal serial bus (USB) port, or the like. The recording medium 305 is a nonvolatile memory that stores data written under the control of the recording medium I/F 304. The recording medium 305 is, for example, a disk, a semiconductor memory, a USB memory, or the like. The recording medium 305 may be attachable to and detachable from the generation device 100.

The generation device 100 may include, for example, a keyboard, a mouse, a display, a printer, a scanner, a microphone, a speaker, and the like in addition to the above-described components. Furthermore, the generation device 100 may include a plurality of the recording media I/F 304 and the recording media 305. Furthermore, the generation device 100 does not have to include the recording medium I/F 304 and the recording medium 305.

(Content Stored in Property Information Management Table 400)

Next, an example of content stored in a property information management table 400 will be described with reference to FIG. 4. The property information management table 400 is implemented by a storage area such as the memory 302 or the recording medium 305 of the generation device 100 illustrated in FIG. 3, for example.

FIG. 4 is an explanatory diagram illustrating an example of content stored in the property information management table 400. As illustrated in FIG. 4, the property information management table 400 has fields for a name and a value. In the property information management table 400, property information is stored as record 400-a by setting information in each field for every attribute name, a is any integer.

In the example of FIG. 4, the property information management table 400 stores property information related to the container as a record. In the name field, a name that identifies the attribute is set. In the name field, for example, Type, Name, Id, ProcessId, Status, PodName, or the like is set as a name for identifying the attribute. The value of the attribute is set in the value field.

In the example of FIG. 4, the value of the attribute of Type is a value “container” indicating that the property information is related to the container. Furthermore, the value of the attribute of Name is a value “reviews” Indicating a name given to the container. The value of the attribute of Id is a value indicating an Id attached to the container. The value of the attribute of ProcessId is a value indicating ProcessId attached to the container. The value of the attribute of Status is a value indicating the status of the container. The value of the attribute of Status is, for example, a value “running” indicating that the container is running. The value of the attribute of PodName is a value indicating a name given to the Pod that contains the container.

In the example of FIG. 4, the case where the property information management table 400 that stores the property information regarding the container as a record exists has been described, but the embodiment is not limited to this. For example, there may further be cases where a property information management table 400 that stores property information related to NI as a record exists. For property information regarding NI, for example, FIGS. 10 and 11 can be referred to.

(Content Stored in Metrics Information Management Table 500)

Next, an example of content stored in a metrics information management table 500 will be described with reference to FIG. 5. The metrics information management table 500 is implemented by a storage area such as the memory 302 or the recording medium 305 of the generation device 100 illustrated in FIG. 3, for example.

FIG. 5 is an explanatory diagram illustrating an example of content stored in the metrics information management table 500. As illustrated in FIG. 5, the metrics information management table 500 has fields for date and time, CPU usage rate, and disk IO. In the metrics information management table 500, generation information is stored as a record 500-b by setting information in each field for every date and time. b is any integer.

In the example of FIG. 5, the metrics information management table 500 stores the metrics information regarding the container as a record. The date and time are set in the date and time fields. In the CPU usage rate field, the CPU usage rate is set as a performance value of the container at the set date and time. The unit of CPU usage rate is, for example, %. In the disk field, disk IO is set as a performance value of the container at the set date and time. The unit of disk IO is, for example, IOPS.

The metrics information management table 500 may have fields for other performance values related to the container in addition to the fields for CPU usage rate and disk IO, or in place of the fields for CPU usage rate and disk IO. Other performance values are, for example, memory usage rate and the like. The unit of memory usage rate is, for example, %.

In the example of FIG. 5, the case where the metrics information management table 500 that stores metrics information regarding the container as a record exists has been described, but the present embodiment is not limited to this. For example, there may further be cases where a metrics information management table 500 that stores metrics information regarding NI as a record exists. For metrics information regarding NI, for example, FIG. 12 can be referred to.

(Content Stored in Node-Pod Connection Information Management Table 600)

Next, an example of content stored in a node-Pod connection information management table 600 will be described with reference to FIG. 6. The node-Pod connection information management table 600 is implemented by a storage area such as the memory 302 or the recording medium 305 of the generation device 100 illustrated in FIG. 3, for example.

FIG. 6 is an explanatory diagram illustrating an example of content stored in the node-Pod connection information management table 600. As illustrated in FIG. 6, the node-Pod connection information management table 600 has fields for nodes and Pods. In the node-Pod connection information management table 600, the node-Pod connection information is stored as a record 600-c by setting information in each field for every node. c is any integer.

In the node field, identification information for identifying a node is set. In the field of Pod, identification information for identifying a Pod started on the node is set.

(Content Stored in Node-NI Connection Information Management Table 700)

Next, an example of content stored in a node-NI connection information management table 700 will be described with reference to FIG. 7. The node-NI connection information management table 700 is implemented by a storage area such as the memory 302 or the recording medium 305 of the generation device 100 illustrated in FIG. 3, for example.

FIG. 7 is an explanatory diagram illustrating an example of content stored in the node-NI connection information management table 700. As illustrated in FIG. 7, the node-NI connection information management table 700 has fields for node and NI. The node-NI connection information management table 700 stores node-NI connection information as a record 700-d by setting information in each field for every node. d is any integer.

In the node field, identification information for identifying a node is set. The NI field is set with identification information that identifies the NI owned by the node.

(Content Stored in Pod-Container Connection Information Management Table 800)

Next, an example of content stored in a Pod-container connection information management table 800 will be described with reference to FIG. 8. The Pod-container connection information management table 800 is implemented by a storage area such as the memory 302 or the recording medium 305 of the generation device 100 illustrated in FIG. 3, for example.

FIG. 8 is an explanatory diagram illustrating an example of the content stored in the Pod-container connection information management table 800. As illustrated in FIG. 8, the Pod-container connection information management table 800 has fields for Pod and container. In the Pod-container connection information management table 800, the Pod-container connection information is stored as a record 800-e by setting information in each field for every Pod. e is any integer.

In the field of Pod, identification information for identifying a Pod started on the node is set. In the container field, identification information that is started on the node and identifies the container included in the Pod is set.

(Content Stored in Container-NI Connection Information Management Table 900)

Next, an example of content stored in a container-NI connection information management table 900 will be described with reference to FIG. 9. The container-NI connection information management table 900 is implemented by a storage area such as the memory 302 or the recording medium 305 of the generation device 100 illustrated in FIG. 3, for example.

FIG. 9 is an explanatory diagram illustrating an example of content stored in the container-NI connection information management table 900. As illustrated in FIG. 9, the container-NI connection information management table 900 has fields for container and NI. In the container-NI connection information management table 900, the container-NI connection information is stored as a record 900-f by setting information in each field for every container. f is any integer.

Identification Information that identifies the container is set in the field of the container. In the NI field, identification information that identifies NI used by the container among the NIs owned by the node is set.

(Content Stored in Pre-Movement Property Information Management Table 1000)

Next, an example of content stored in the pre-movement property information management table 1000 will be described with reference to FIG. 10. The pre-movement property information management table 1000 is implemented by a storage area such as the memory 302 or the recording medium 305 of the generation device 100 illustrated in FIG. 3, for example.

FIG. 10 is an explanatory diagram illustrating an example of content stored in the pre-movement property information management table 1000. As illustrated in FIG. 10, the pre-movement property information management table 1000 has fields for name and value. In the pre-movement property information management table 1000, pre-movement property information is stored as a record 1000-g by setting information in each field for every attribute name. g is any integer.

In the example of FIG. 10, the pre-movement property information management table 1000 stores the pre-movement property information related to NI that has been used by the container before being moved as a record. In the name field, a name that identifies the attribute is set. In the name field, for example, Type, VportTap, VportNum, VportIpAddr, NodeName, or the like is set as a name for identifying the attribute. The value of the attribute is set in the value field.

In the example of FIG. 10, the value of the attribute of Type is a value “NI” indicating that the pre-movement property information is related to NI that has been used by the container before being moved. Furthermore, the value of the attribute of VportTap is a value indicating a network tap corresponding to NI that has been used by the container before being moved. The value of the attribute of VportNum is a value indicating a number assigned to NI that has been used by the container before being moved. The value of the attribute of VportIpAddr is a value indicating an IP address given to NI that has been used by the container before being moved. The value of the attribute of NodeName is a value indicating a name that identifies the node that has NI that has been used by the container before being moved.

In the example of FIG. 10, the case has been described where the pre-movement property information management table 1000 that stores the pre-movement property information regarding NI that has been used by the container before being moved as a record exists, but the present embodiment is not limited to this. For example, there may further be cases where a pre-movement property information management table 1000 that stores the pre-movement property information related to the container before being moved as a record exists. For pre-movement property information regarding the container before being moved, for example, FIG. 4 can be referred to.

(Content Stored in Post-Movement Property Information Management Table 1100)

Next, an example of content stored in the post-movement property information management table 1100 will be described with reference to FIG. 11. The post-movement property information management table 1100 is implemented by a storage area such as the memory 302 or the recording medium 305 of the generation device 100 illustrated in FIG. 3, for example.

FIG. 11 is an explanatory diagram illustrating an example of content stored in the post-movement property information management table 1100. As illustrated in FIG. 11, the post-movement property information management table 1100 has fields for name and value. In the post-movement property information management table 1100, the post-movement property information is stored as a record 1100-h by setting information in each field for every attribute name. h is any integer.

In the example of FIG. 11, the post-movement property information management table 1100 stores post-movement property information related to NI being used by the container after being moved as a record. In the name field, a name that identifies the attribute is set. In the name field, for example, Type, VportTap, VportNum, VportIpAddr, NodeName, or the like is set as a name for identifying the attribute. The value of the attribute is set in the value field.

In the example of FIG. 11, the value of the attribute of Type is the value “NI” indicating that the post-movement property information is related to NI being used by the container after being moved. Furthermore, the value of the attribute of VportTap is a value indicating a network tap corresponding to NI used by the container after being moved. The value of the attribute of VportNum is a value indicating a number assigned to NI being used by the container after being moved. The value of the attribute of VportIpAddr is a value indicating an IP address given to NI being used by the container after being moved. The value of the attribute of NodeName is a value indicating a name that identifies the node that has NI being used by the container after being moved.

In the example of FIG. 11, the case has been described where the post-movement property information management table 1100 that stores the post-movement property information regarding NI being used by the container after being moved as a record exists, but the embodiment is not limited to this. For example, there may further be cases where a post-movement property information management table 1100 that stores the post-movement property information regarding the container after being moved as a record exists. For the post-movement property information regarding the container after being moved, for example, FIG. 4 can be referred to.

(Content Stored in Post-Combination Metrics Information Management Table 1200)

Next, an example of content stored in a post-combination metrics information management table 1200 will be described with reference to FIG. 12. The post-combination metrics information management table 1200 is implemented by a storage area such as the memory 302 or the recording medium 305 of the generation device 100 illustrated in FIG. 3, for example.

FIG. 12 is an explanatory diagram illustrating an example of content stored in the post-combination metrics information management table 1200. As illustrated in FIG. 12, the post-combination metrics information management table 1200 has fields for before and after, date and time, traffic, and band usage rate. The post-combination metrics information management table 1200 stores the post-combination metrics information as a record 1200-i by setting information in each field for every date and time. i is any integer.

In the example of FIG. 12, the post-combination metrics information management table 1200 stores the metrics information regarding NI being used by the container before and after movement as a record. Flag information is set in the before and after field to indicate whether it is a record related to NI that has been used by the container before being moved or a record related to NI being used by the container after being moved. If the flag information is “before”, it indicates that it is a record related to NI that has been used by the container before being moved. If the flag information is “after”, it indicates that it is a record related to NI being used by the container after being moved.

The date and time are set in the date and time fields. In the traffic field, traffic is set as the performance value of NI at the set date and time. The unit of traffic is, for example, Mbps. In the band usage field, the band usage rate is set as the performance value of NI at the set date and time. The unit of band usage rate is, for example, %.

The post-combination metrics information management table 1200 may have fields for other performance values related to NI in addition to the fields for traffic and band usage rate, or in place of the fields for traffic and band usage rate. Other performance values are, for example, transmission error rate and the like. The unit of the transmission error rate is, for example, %.

In the example of FIG. 12, the case has been described where the post-combination metrics information management table 1200 that stores the metrics information regarding NI being used by the container before and after movement exists as a record, but the embodiment is not limited to this. For example, there may further be cases where a post-combination metrics information management table 1200 that stores metrics information regarding the container before and after movement as a record exists. For the metrics information regarding the container before and after movement, for example, FIG. 5 can be referred to.

(Hardware Configuration Example of Movement Management Device 201)

A hardware configuration example of the movement management device 201 is similar to the hardware configuration example of the generation device 100 illustrated in FIG. 3, and thus the description thereof is omitted.

(Hardware Configuration Example of Node Device 202)

A hardware configuration example of the node device 202 is similar to the hardware configuration example of the generation device 100 illustrated in FIG. 3, and thus the description thereof is omitted.

(Functional Configuration Example of Generation Device 100)

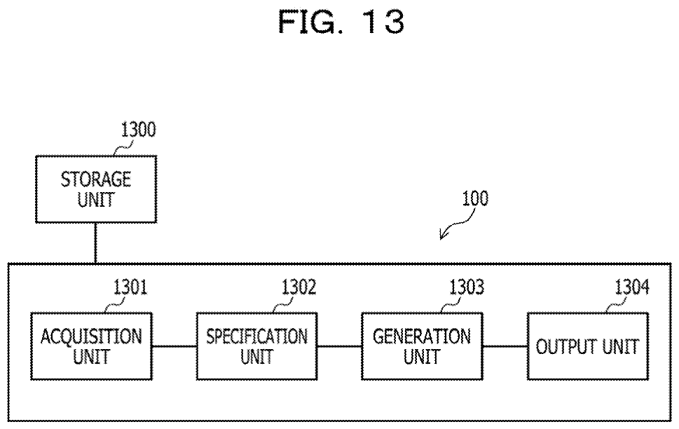

Next, a functional configuration example of the generation device 100 will be described with reference to FIG. 13.

FIG. 13 is a block diagram illustrating a functional configuration example of the generation device 100. The generation device 100 includes a storage unit 1300, an acquisition unit 1301, a specification unit 1302, a generation unit 1303, and an output unit 1304.

The storage unit 1300 is implemented by the storage area such as the memory 302 or the recording medium 305 illustrated in FIG. 3, for example. Hereinafter, a case where the storage unit 1300 is included in the generation device 100 will be described, but the embodiment is not limited to this case. For example, the storage unit 1300 may be included in a device different from the generation device 100, and content stored in the storage unit 1300 may be able to be referred to by the generation device 100.

The acquisition unit 1301 to the output unit 1304 function as an example of a control unit. For example, the acquisition unit 1301 to the output unit 1304 implement functions thereof by causing the CPU 301 to execute a program stored in the storage area such as the memory 302 or the recording medium 305 illustrated in FIG. 3 or by the network I/F 303. A processing result of each functional unit is stored in, for example, the storage area such as the memory 302 or the recording medium 305 illustrated in FIG. 3.

The storage unit 1300 stores various types of information referred to or updated in the processing of each functional unit. The storage unit 1300 stores the attribute information of each container of the plurality of containers. The attribute information includes, for example, identification information that identifies the container. The attribute information is, for example, the property information illustrated in FIG. 4. The storage unit 1300 stores the attribute information of each NI of a plurality of Ns. The NI is owned by a node. The node is, for example, the node device 202 illustrated in FIG. 2. The NI is achieved by, for example, an NI-Card. The attribute information includes identification information that identifies NI. The attribute information is, for example, the property information illustrated in FIG. 4. For example, the storage unit 1300 stores the property information management table 400 illustrated in FIG. 4.

The storage unit 1300 stores performance information of each container of a plurality of containers. The performance information is, for example, time-series information indicating a time change in performance value of the container. The performance information is, for example, the metrics information illustrated in FIG. 5. The storage unit 1300 stores performance information of each NI of the plurality of NIs. The performance information is time-series information indicating a time change in performance value of NI. The performance information is, for example, the metrics information illustrated in FIG. 5. For example, the storage unit 1300 stores the metrics information management table 500 illustrated in FIG. 5.

The storage unit 1300 stores information that makes it possible to specify NI owned by the node. The information that makes it possible to specify NI owned by the node is, for example, the node-NI connection information illustrated in FIG. 7. The storage unit 1300 stores, for example, the node-NI connection information management table 700 illustrated in FIG. 7. The storage unit 1300 stores information that makes it possible to specify the NI used by the container. The information that makes it possible to specify the NI used by the container is, for example, the container-NI connection information illustrated in FIG. 9. The storage unit 1300 stores, for example, the container-NI connection information management table 900 illustrated in FIG. 9.

The storage unit 1300 stores performance information of NI that has been used by the container before being moved when the container is moved. The performance information of NI that has been used by the container before being moved is, for example, the pre-movement property information illustrated in FIG. 10. The storage unit 1300 stores, for example, the pre-movement property information management table 1000 illustrated in FIG. 10. The storage unit 1300 stores the performance information of NI being used by the container after being moved when the container has been moved. The performance information of NI being used by the container after being moved is, for example, the post-movement property information illustrated in FIG. 11. The storage unit 1300 stores, for example, the post-movement property information management table 1100 illustrated in FIG. 11.

The storage unit 1300 stores correspondence information that associates the performance information of NI that has been used by the container before being moved with the performance information of NI being used by the container after being moved when the container has been moved. The correspondence information is generated by, for example, the generation unit 1303.

The correspondence information is, for example, combined information obtained by combining the performance information of NI that has been used by the container before being moved and the performance information of NI being used by the container after being moved. For example, the correspondence information is combined information obtained by combining the time series of performance values represented by the performance information of NI being used by the container after being moved to a rear of the time series of performance values represented by the performance information of NI that has been used by the container before being moved. The correspondence information may be, for example, information in which first identification information that identifies a first NI that has been used by the container before being moved and second identification information that identifies a second NI being used by the container after being moved are associated with each other.

For example, in a case where the container is moved, the storage unit 1300 stores combined information obtained by combining the performance information of NI that has been used by the container before being moved and the performance information of NI being used by the container after being moved. The combined information is, for example, the post-combination metrics information illustrated in FIG. 12. For example, the storage unit 1300 stores the post-combination metrics information management table 1200 illustrated in FIG. 12.

The acquisition unit 1301 acquires various types of information to be used for processing of each functional unit. The acquisition unit 1301 stores the acquired various types of information in the storage unit 1300 or outputs the acquired various types of information to each functional unit. Furthermore, the acquisition unit 1301 may output the various types of information stored in the storage unit 1300 to each functional unit. The acquisition unit 1301 acquires the various types of information on the basis of, for example, operation input of the user. The acquisition unit 1301 may receive the various types of information from a device different from the generation device 100, for example.

The acquisition unit 1301 acquires performance information of each container of a plurality of containers. The acquisition unit 1301 acquires, for example, the performance information of each container of the plurality of containers by periodically collecting the performance information from each node of the plurality of nodes. Thus, the acquisition unit 1301 may acquire various information useful for the processing of each functional unit.

The acquisition unit 1301 acquires the performance information of each of a plurality of NIs. The acquisition unit 1301 acquires, for example, the performance information of each NI of the plurality of NIs by periodically collecting the performance information from each node of the plurality of nodes. Thus, the acquisition unit 1301 may acquire various information useful for the processing of each functional unit.

The acquisition unit 1301 acquires information that makes it possible to specify the NI owned by the node. The acquisition unit 1301 acquires, for example, information owned by a node that makes it possible to specify the NI by collecting information from each node of a plurality of nodes. The acquisition unit 1301 may acquire information that makes the NI owned by the node identifiable by accepting an input of the information that makes it possible to specify the NI owned by the node, for example, based on an operation input of the user. Thus, the acquisition unit 1301 may acquire various information useful for the processing of each functional unit.

The acquisition unit 1301 acquires information that makes it possible to specify the NI used by the container. For example, the acquisition unit 1301 periodically acquires information that makes it possible to specify the NI used by the container from each node of a plurality of nodes. Thus, the acquisition unit 1301 may acquire various information useful for the processing of each functional unit.

The acquisition unit 1301 acquires the performance information of the first NI. The first NI is the NI owned by the first node. For example, among a plurality of NIs owned by different nodes, the acquisition unit 1301 sets the NI having performance information representing that a performance value or the amount of change in the performance value has become zero before or after a certain time point as the first NI. The certain time point is, for example, when at least some container has been moved. The certain time point may be, for example, a preset periodic time point. Then, the acquisition unit 1301 acquires, for example, the performance information of the set first NI. For example, the acquisition unit 1301 acquires performance information of the set first NI by extracting the performance information of the set first NI from the performance information of each NI of the plurality of NIs. Thus, the acquisition unit 1301 may acquire the performance information of the first NI that has been used by the container before being moved, which is disconnected from the performance information of the second NI being used by the container after being moved due to movement of the container.

The acquisition unit 1301 acquires the performance information of the container after being moved. The container after being moved is a container after being moved from the first node to a second node different from the first node. The acquisition unit 1301 acquires, for example, performance information of the container after being moved, which is implemented in the second node, corresponding to the container before being moved that has been implemented in a first node and has been using the set first NI. For example, the acquisition unit 1301 specifies a container before being moved that has been using the set first NI based on information that makes it possible to specify the NI used by each container of a plurality of containers before a certain time point. Next, for example, the acquisition unit 1301 specifies the container after being moved corresponding to the specified container before being moved based on the attribute information of each container of the plurality of containers each of before and after a certain time point. Then, for example, the acquisition unit 1301 acquires the performance information of the specified container after being moved. For example, the acquisition unit 1301 extracts performance information of the specified container after being moved from the performance information of each container of the plurality of containers, and thereby acquire the performance information of the specified container after being moved. Thus, the acquisition unit 1301 may acquire the performance information of the container after being moved that may be a due to associate the performance information of the first NI that has been used by the container before being moved with the performance information of the second NI being used by the container after being moved.

The acquisition unit 1301 acquires performance information of a container regenerated in the same node. The acquisition unit 1301 acquires, for example, performance information of a container once deleted and regenerated in the first node. For example, the acquisition unit 1301 acquires performance information of a container after regeneration corresponding to a container before restart that has been using the set first NI. Further, for example, the acquisition unit 1301 specifies the container before restart that has been using the set first NI based on information that makes it possible to specify the NI used by each container of a plurality of containers before a certain time point. Next, for example, the acquisition unit 1301 specifies the container after regeneration corresponding to the specified container before restart based on the attribute information of each container of a plurality of containers before and after a certain time point. Then, for example, the acquisition unit 1301 acquires the performance information of the specified container after regeneration. Further, for example, the acquisition unit 1301 extracts the performance information of the specified container after regeneration from the performance information of each container of the plurality of containers, and thereby acquires the performance information of the specified container after regeneration. Thus, the acquisition unit 1301 may make it possible to associate the performance information of the first NI that has been used by the container before restart with the performance information of the second NI being used by the container after restart, which has been interrupted not only by movement of the container but by the restart of the container.

The acquisition unit 1301 may accept a start trigger to start processing of any of the functional units. The start trigger is, for example, a predetermined operation input by the user. The start trigger may be, for example, reception of predetermined information from another computer. The start trigger may be, for example, output of predetermined information by any of the functional units. The start trigger may be at a predetermined timing. The predetermined timing is, for example, a periodic timing.

For example, the acquisition unit 1301 accepts that a predetermined operation input by the user has been made as a start bigger for starting processing of the acquisition unit 1301 to the output unit 1304. For example, the acquisition unit 1301 accepts that a predetermined timing has been reached as a start trigger for starting processing of the acquisition unit 1301 to the output unit 1304. For example, the acquisition unit 1301 accepts that deletion, start, or movement of the container has been detected as a start trigger for starting processing of the acquisition unit 1301 to the output unit 1304. For example, the acquisition unit 1301 accepts that a notification of deletion, start, or movement of the container has been accepted from any of the plurality of nodes as a start trigger to start processing of the acquisition unit 1301 to the output unit 1304.

The specification unit 1302 specifies the performance information of the second NI, which represents a feature similar to a feature represented by the acquired performance information of the container after being moved, among the performance information of the NI owned by the second node. The feature is expressed by, for example, a time point and a direction in which the performance value changes by a certain amount or more. For example, the feature is expressed by the distribution at a time point when the performance value increases by a certain amount or more. The feature is represented by, for example, the distribution at a time point when the performance value exceeds or falls below a threshold. The feature is represented by, for example, a statistical value of a performance value. The statistical value is, for example, maximum value, minimum value, mean, mode, median, variance, standard deviation, or the like.

The specification unit 1302 calculates, as similarity, the number of times or percentage for time points when the performance value has increased by a certain amount or more match, for example, between the time series of performance values indicated by the performance information of NI owned by the second node and the time series of the performance values indicated by the performance information of the container after being moved. Then, the specification unit 1302 specifies, for example, the performance information of one of the NIs having the largest calculated similarity among the performance information of the NIs owned by the second node as the performance information of the second NI. Thus, the specification unit 1302 makes it possible to associate the performance information of the first NI that has been used by the container before being moved with the performance information of the second NI being used by the container after being moved.

For example, the specification unit 1302 extracts the performance information representing that the performance value or the amount of change in the performance value is no longer zero before or after a certain time point among the performance information of NI owned by the second node. Then, the specification unit 1302 specifies, for example, the performance information of the second NI, which represents a feature similar to a feature represented by the acquired performance information of the container after being moved among the extracted performance information. Thus, the specification unit 1302 may reduce the amount of processing needed when specifying the performance information of the second NI being used by the container after being moved. The specification unit 1302 may reduce the number of pieces of performance information for checking the similarity of features when identifying the performance information of the second NI being used by the container after being moved, and may reduce the amount of processing, for example.

For example, the specification unit 1302 measures the number of NIs that have been used by the container before being moved among the NIs owned by the first node. Next, for example, for every combination of performance information for the measured number of NI owned by the second node, the specification unit 1302 generates synthetic information with which the combination is synthesized. Then, the specification unit 1302 specifies the performance information of the second NI included in, for example, a combination that is the synthesis source of any of the synthetic information representing a feature similar to a feature represented by the acquired performance information of the container after being moved among the generated synthetic information. Thus, even when there are multiple NIs used by the container, the specification unit 1302 may make it possible to associate the performance information of the first NI that has been used by the container before being moved with the performance information of the second NI being used by the container after being moved. The specification unit 1302 may handle, for example, cases where features of the performance information of the container after being moved are mixed with features of the performance information of each NI of a plurality of NIs.

For example, the specification unit 1302 specifies any synthetic information that represents a feature similar to the feature represented by the acquired performance information of the container after being moved among the generated synthetic information. Then, for example, the specification unit 1302 specifies the performance information of the second NI that is included in the combination that is the synthesis source of the specified synthetic information, and represents a feature similar to the feature represented by the performance information of the first NI. Further, for example, the specification unit 1302 calculates the degree of overlap in the range from the maximum value to the minimum value of the performance value between the time series of the performance values indicated by the performance information of NI included in the combination that is the synthesis source of the specified synthetic information and the time series of the performance values indicated by the performance information of the first NI. Further, for example, the specification unit 1302 sets the calculated degree as the similarity of the performance information of NI included in the combination that is the synthesis source of the specified synthetic information to the performance information of the first NI. Then, for example, the specification unit 1302 specifies the performance information of NI that is included in the combination that is the synthesis source of the specified synthetic information and has the largest set similarity as the performance information of the second NI. Thus, the specification unit 1302 may specify the performance information of the second NI to be associated with the performance information of the first NI among the performance information of each NI of the plurality of NIs included in the combination that is the synthesis source of the synthetic information.

The specification unit 1302 specifies the performance information of the second NI that represents a feature similar to a feature represented by the acquired performance information of the container after regeneration among the performance information of NI owned by the first node. In the specification unit 1302 calculates, for example, the number or percentage of match of time points when the performance value increases by a certain amount or more as the degree of similarity between the time series of performance values indicated by the performance information of NI owned by the first node and the time series of performance values indicated by the performance information of the container after regeneration. Then, the specification unit 1302 specifies, for example, the performance information of one of the NIs having the largest calculated similarity among the performance information of NI owned by the first node as the performance information of the second NI. Thus, the specification unit 1302 may associate the performance information of the first NI that has been used by the container before restart with the performance information of the second NI being used by the container after restart.

The generation unit 1303 generates correspondence information that associates the acquired performance information of the first NI with the specified performance information of the second NI. For example, the generation unit 1303 generates combined information obtained by combining a time series of the performance values represented by the performance information of the specified second NI to a rear of a time series of the performance values represented by the performance information of the first NI. Thus, the generation unit 1303 may facilitate use of the performance information of the first NI and the performance information of the second NI.

For example, the generation unit 1303 generates correspondence information that associates identification information that identifies the container after being moved, the performance information of the first NI, and the specified performance information of the second NI. For example, the generation unit 1303 generates combined information obtained by combining the time series of the performance values represented by the performance information of the specified second NI to the rear of the time series of the performance values represented by the performance information of the first NI, in association with the identification information that identifies the container after being moved. Thus, the generation unit 1303 may facilitate use of the performance information of the first NI and the performance information of the second NI. Furthermore, the generation unit 1303 may facilitate specification of the container to which the performance information of the first NI and the performance information of the second NI are related based on the correspondence information, and may further facilitate use of the performance information of the first NI and the performance information of the second NI.

The generation unit 1303 generates, for example, correspondence information in which the first identification information that identifies the first NI and the second identification information that identifies the second NI are associated with each other. Thus, the generation unit 1303 may indirectly associate the performance information of the first NI with the performance information of the second NI. The generation unit 1303 may facilitate use of the performance information of the first NI and the performance information of the second NI.

For example, the generation unit 1303 generates correspondence information in which the identification information that identifies the container after being moved, the first identification information that identifies the first NI, and the second identification information that identifies the second NI. Thus, the generation unit 1303 may indirectly associate the performance information of the first NI with the performance information of the second NI. The generation unit 1303 may facilitate use of the performance information of the first NI and the performance information of the second NI. Furthermore, the generation unit 1303 may facilitate specification of the container to which the performance information of the first NI and the performance information of the second NI are related based on the correspondence information, and may further facilitate use of the performance information of the first NI and the performance information of the second NI.

The output unit 1304 outputs a processing result of at least one of the functional units. An output format is, for example, display on a display, print output to a printer, transmission to an external device by the network I/F 303, or storage to the storage area of the memory 302, the recording medium 305, or the like. Thus, the output unit 1304 makes it possible to notify the user of the processing result of at least one of the functional units, and may improve convenience of the generation device 100.

The output unit 1304 outputs the generated correspondence information. The output unit 1304 outputs, for example, the generated correspondence information so that the user can refer to it. For example, the output unit 1304 displays a graph representing a summary of time changes in performance values of different NIs used by the same container before and after movement, which are indicated by the generated correspondence information, so that the user can refer to it. Thus, the output unit 1304 may allow the user to intuitively grasp time changes in performance values of different NIs used by the same container before and after movement. The output unit 1304 may allow the user to monitor or analyze the performance values of different NIs used by the same container before and after movement. Furthermore, the output unit 1304 may allow the user to predict time changes in future performance value of NI being used by the container after being moved, based on performance values of different NIs used by the same container before and after movement.

For example, the output unit 1304 outputs, for example, the generated correspondence information so that an application, which monitors the performance value of NI, analyzes the performance value of NI, or predicts a future performance value of the NI, owned by its own device can refer to it. Thus, the output unit 1304 may accurately monitor or accurately analyze the performance value of NI by the application owned by its own device. Furthermore, the output unit 1304 may make time changes in future performance value of NI being used by the container after being moved accurately predictable by the application owned by its own device based on the different performance values of NI used by the same container before and after movement.

The output unit 1304 outputs, for example, the generated correspondence information so that other computers can refer to it, which monitors the performance value of NI, analyzes the performance value of NI, or predicts a future performance value of NI. Thus, the output unit 1304 may accurately monitor or accurately analyze the performance value of NI by another computer. Furthermore, the output unit 1304 may make time changes in future performance value of NI being used by the container after being moved accurately predictable based on the performance values of different NIs used by the same container before and after movement by another computer.

Furthermore, the correspondence information may associate the performance information of the first NI that has been used by the container before restart and the performance information of the second NI being used by the container after restart. In this case, the output unit 1304 may facilitate monitoring or analysis of the performance values of different NIs used by the same container before and after restart. Furthermore, the output unit 1304 may facilitate prediction of time changes in future performance value of NI being used by the container after restart based on the performance values of different NIs used by the same container before and after restart.

(Specific Functional Configuration Example of Generation Device 100)

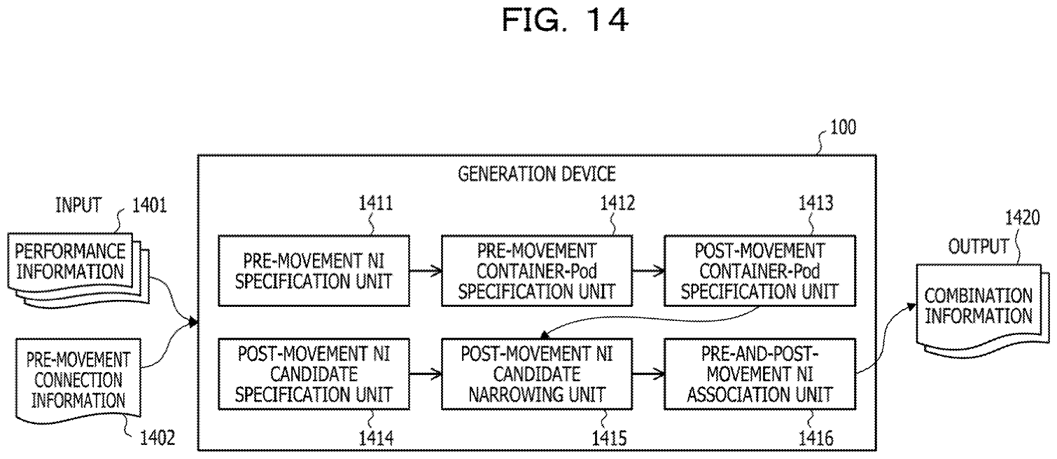

Next, a specific functional configuration example of the generation device 100 will be described with reference to FIG. 14.

FIG. 14 is a block diagram illustrating a specific functional configuration example of the generation device 100. The generation device 100 includes a pre-movement NI specification unit 1411, a pre-movement container-Pod specification unit 1412, a post-movement container-Pod specification unit 1413, a post-movement NI candidate specification unit 1414, and a post-movement NI candidate narrowing unit 1415, and a pre-and-post-movement NI association unit 1416.

The generation device 100 acquires performance information 1401 and pre-movement connection information 1402. The performance information 1401 includes metrics information of container and metrics information of NI. The performance information 1401 includes property information of container and property information of NI. The pre-movement connection information 1402 includes container-NI connection information indicating the connection relationship between a container and NI at least at a time point before some container is moved. The pre-movement NI specification unit 1411 to the pre-and-post-movement NI association unit 1416 may implement, for example, the acquisition unit 1301 to the output unit 1304 illustrated in FIG. 13.

The pre-movement NI specification unit 1411 specifies pre-movement NI that is determined to have been used by the pre-movement container based on the performance information 1401. The pre-movement NI specification unit 1411 specifies NI that satisfies a condition as the pre-movement NI, for example, based on the metrics information of the NI included in the performance information 1401. The condition is, for example, that the performance value or the amount of change in the performance value becomes zero at least at a time point after some container is moved.

The pre-movement container-Pod specification unit 1412 specifies a pre-movement pair, which is a combination of a pre-movement container and a pre-movement Pod corresponding to the pre-movement NI. The pre-movement container-Pod specification unit 1412 specifies, for example, the pre-movement container corresponding to the pre-movement NI based on the pre-movement connection information 1402, and specifies a pre-movement Pod including the pre-movement container. Then, the pre-movement container-Pod specification unit 1412 specifies, for example, a pre-movement pair that is a combination of the specified pre-movement container and the specified pre-movement Pod.

The post-movement container-Pod specification unit 1413 specifies a post-movement pair, which is a combination of a post-movement container and a post-movement Pod corresponding to the pre-movement container, based on the performance information 1401. The post-movement container-Pod specification unit 1413 specifies, for example, the post-movement container corresponding to the pre-movement container based on the property information of the container included in the performance information 1401, and specifies a post-movement Pod including the post-movement container. Then, the post-movement container-Pod specification unit 1413 specifies, for example, a post-movement pair that is a combination of the specified post-movement container and the specified post-movement Pod.

The post-movement NI candidate specification unit 1414 specifies a post-movement NI candidate that is determined to be used by the post-movement container based on the performance information 1401. The post-movement NI candidate specification unit 1414 specifies NI that satisfies a condition as a post-movement NI candidate, for example, based on the metrics information of NI included in the performance information 1401. The condition is, for example, that the performance value or the amount of change in the performance value is no longer zero, at least at a time point after some container is moved.

The post-movement NI candidate narrowing unit 1415 extracts one or more post-movement NI candidates from the specified post-movement NI candidates based on the specified post-movement pair and the performance information 1401. For example, the post-movement NI candidate narrowing unit 1415 specifies a node in which the post-movement container that forms the specified post-movement pair has been started from the specified post-movement NI candidates based on the property information of the container included in the performance information 1401. Then, the post-movement NI candidate narrowing unit 1415 extracts, for example, one or more post-movement NI candidates owned by the specified node from the specified post-movement NI candidates.

The pre-and-post-movement NI association unit 1416 associates the metrics information of the pre-movement NI with the metrics information of any of the post-movement NI candidates based on the performance information 1401. Next, the pre-and-post-movement NI association unit 1416 generates combined information 1420 combining the metrics information of the pre-movement NI and the metrics information of any of the post-movement NI candidates which are associated. Then, the pre-and-post-movement NI association unit 1416 outputs the generated combined information.

For example, based on the performance information 1401, the pre-and-post-movement NI association unit 1416 calculates the similarity of features of time changes in performance values, with the metrics information of the extracted post-movement NI candidate and the metrics information of the post-movement container that forms the post-movement pair. Next, the pre-and-post-movement NI association unit 1416 specifies, for example, the post-movement NI candidate having the largest calculated similarity among the extracted post-movement NI candidates as the post-movement NI. Then, the pre-and-post-movement NI association unit 1416 associates, for example, the metrics information of the pre-movement NI with the metrics information of the specified post-movement NI.

Thereafter, the pre-and-post-movement NI association unit 1416 generates, for example, combined information combining the metrics information of the pre-movement NI and the metrics information of the post-movement NI. Then, the pre-and-post-movement NI association unit 1416 outputs, for example, the generated combined information so that the user can refer to it. Thus, the generation device 100 may facilitate monitoring or analysis of the performance values of different NIs used by the same container before and after movement. Furthermore, the generation device 100 may facilitate prediction of time changes in future performance value of NI being used by the container after being moved based on the performance values of different NIs used by the same container before and after movement.

(Operation Flow of Generation Device 100)

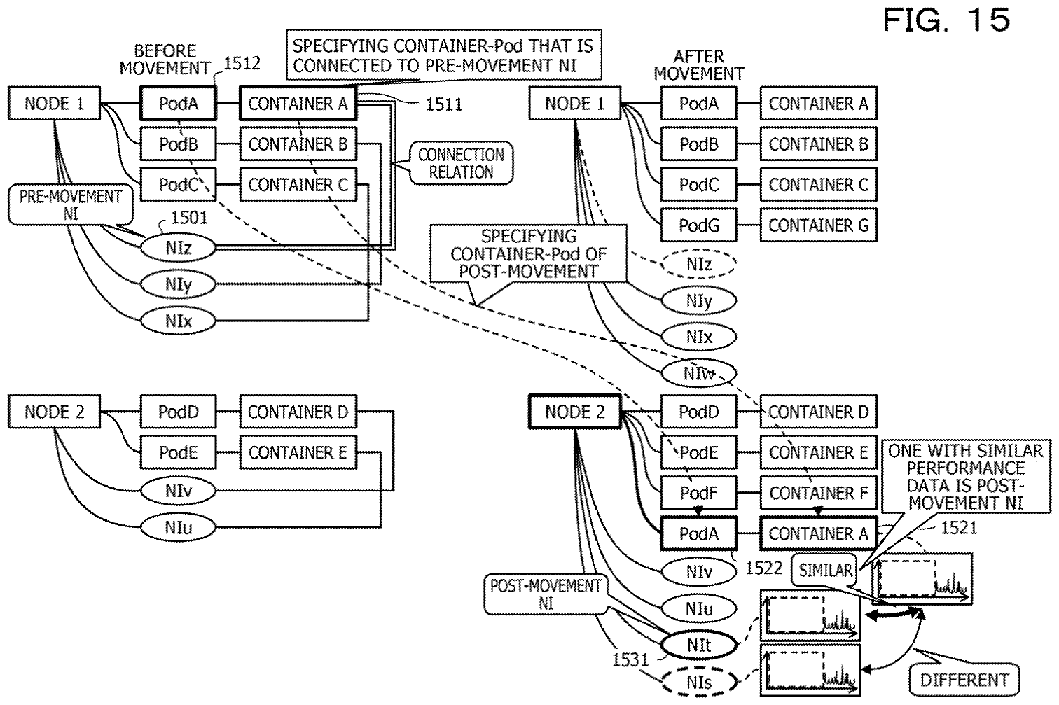

Next, a flow of operation of the generation device 100 will be described with reference to FIG. 15.

FIG. 15 is an explanatory diagram illustrating a flow of operation of the generation device 100. In FIG. 15, there are a node 1 having NIx, NIy, and NIz, and a node 2 having NIu and NIv. It is assumed that a Pod A containing container A on the node 1 is moved to the node 2.

In FIG. 15, the generation device 100 periodically collects container-NI connection information indicating the connection relationship between a container and NI. Thus, it is a situation that the generation device 100 is capable of specifying a pre-movement container and a pre-movement Pod corresponding to a pre-movement NI.

Furthermore, since the generation device 100 collects property information of the container, it is possible to specify a pre-movement Pod including a pre-movement container and a post-movement Pod including a post-movement container. Furthermore, since the post-movement container uses NI, metrics information of a post-movement container and metrics information of NI used by the post-movement container tend to have similar features to each other.

Accordingly, by considering the above-described situation and the above tendency, the generation device 100 is configured to associate metrics information of pre-movement NI that has been used by the with metrics information of post-movement NI being used by the container after being moved. The generation device 100 generates post-combination metrics information by combining, for example, the metrics information of the pre-movement NI that has been used by the container before being moved and the metrics information of the post-movement NI being used by the container after being moved.

In the example of FIG. 15, the generation device 100 specifies a pre-movement NI 1501=NIz. The generation device 100 specifies a pre-movement pair that is a combination of a pre-movement container 1511=container A and a pre-movement Pod 1512=Pod A that is connected to the specified pre-movement NI 1501=NIz. The generation device 100 specifies a post-movement pair that is a combination of a post-movement container 1521=container A and a post-movement Pod 1522=Pod A that corresponds to the specified pre-movement pair.

The generation device 100 specifies a post-movement node=node 2 where the post-movement pairs post-movement container 1521=container A is located. The generation device 100 specifies a post-movement NI 1531=NIt that has metrics information representing a feature most similar to a feature represented by metrics information of the post-movement pair's post-movement container 1521=container A among NIs owned by the specified post-movement node=node 2. The generation device 100 generates post-combination metrics information combining metrics information of the pre-movement NI 1501=NIz and metrics information of the post-movement NI 1531=NIt.

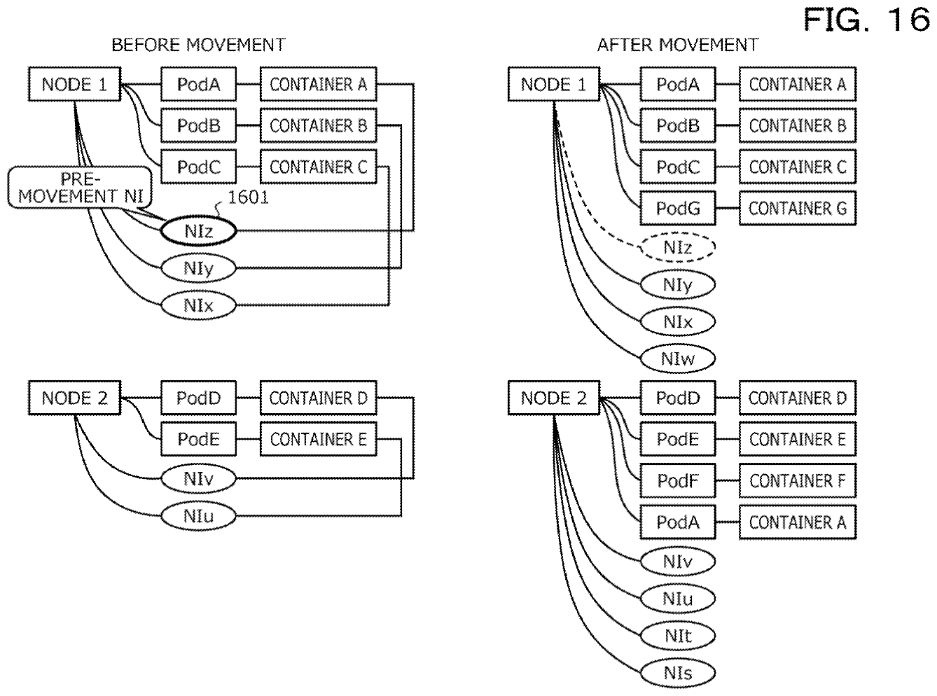

Thus, the generation device 100 may associate the metrics information of different NIs regarding the same container that has been disconnected once. Even if there are multiple containers that are moved, started, or deleted in the same period, the generation device 100 may associate the metrics information of the pre-movement NI used by the pre-movement container and the metrics information of the post-movement NI used by the post-movement container. Thus, the generation device 100 may facilitate use of the metrics information of different NIs regarding the same container. For example, the various processes illustrated in FIG. 15 correspond to various processes illustrated in operation example 1 as will be described later with FIGS. 16 to 21.

(Operation Example 1 of Generation Device 100)

Next, operation example 1 of the generation device 100 will be described with reference to FIGS. 16 to 21.

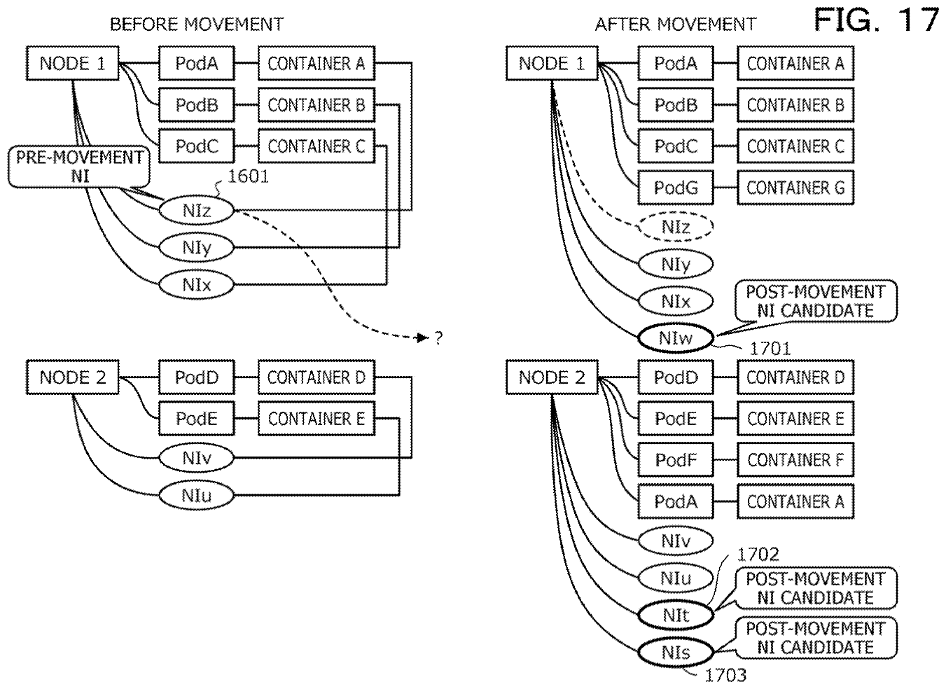

FIGS. 16 to 21 are explanatory views illustrating operation example 1 of the generation device 100. In FIG. 16, the generation device 100 specifies a pre-movement NI 1601=NIz. For example, the generation device 100 specifies the pre-movement NI 1601=NIz in which the performance value or the amount of change in the performance value has become zero after movement of the container, based on respective pieces of metrics information of NI before movement of the container. Thus, the generation device 100 may specify the metrics information of the pre-movement NI that has been used by the container before being moved, which has been disconnected from the metrics information of the post-movement NI being used by the container after being moved due to movement of the container, and may take the metrics information as a processing target. Next, description of FIG. 17 will be given.

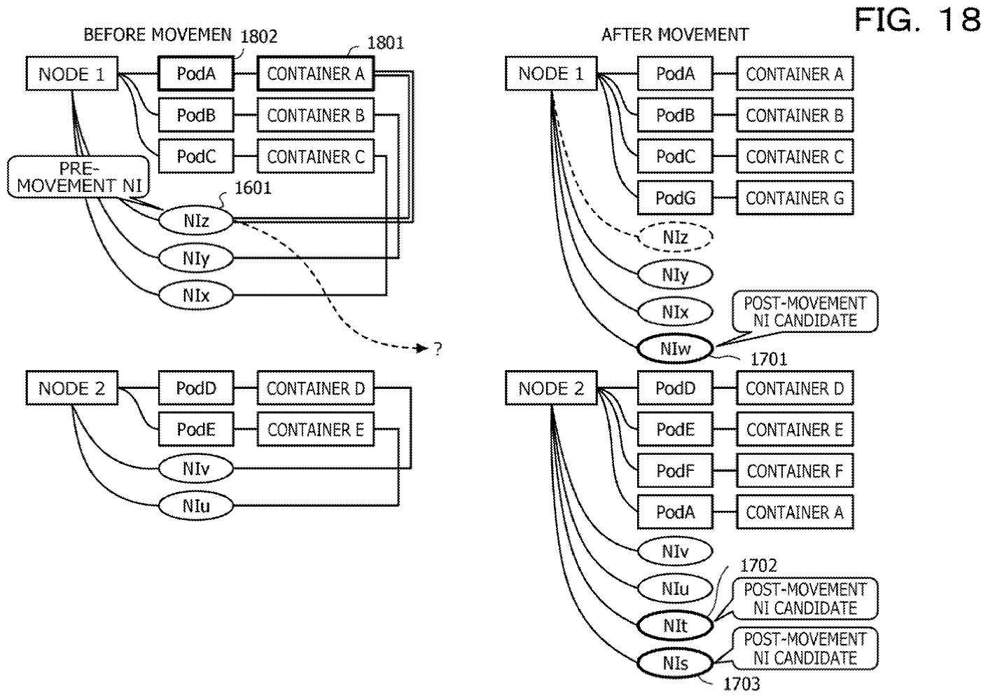

In FIG. 17, the generation device 100 specifies post-movement NI candidates 1701 to 1703=NIw, NIt, NIs that may become post-movement NI corresponding to the pre-movement NI 1601. Here, if there is a plurality of containers that are moved, started, or deleted in the same period, there may be cases where a plurality of post-movement NI candidates that can become a post-movement NI exists. The generation device 100 specifies, for example, the post-movement NI candidates 1701 to 1703=NIw, NIt, NIs in which the performance value or the amount of change in the performance value is no longer zero after movement of the container, based on the respective pieces of metrics information of NI after movement of the container. Thus, the generation device 100 may specify the post-movement NI candidates that can become a post-movement NI, and obtain information that may be used as a due to associate the pre-movement NI with the post-movement NI. Next, description of FIG. 18 will be made.

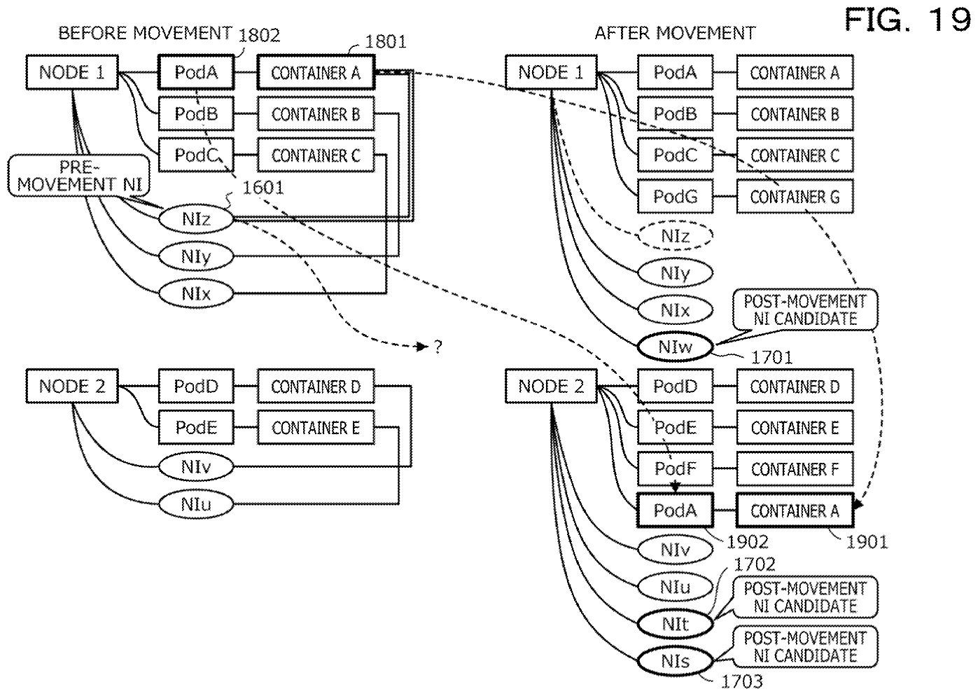

In FIG. 18, the generation device 100 specifies a pre-movement pair that is a combination of a pre-movement container 1801=container A and a pre-movement Pod 1802=Pod A that is connected to the specified pre-movement NI 1601=NIz. The generation device 100 specifies, for example, the pre-movement pair that is a combination of the pre-movement container 1801=container A and the pre-movement Pod 1802=Pod A that is connected to the pre-movement NI 1601=NIz based on the container-NI connection information before movement of the container. Next, description of FIG. 19 will be made.

In FIG. 19, the generation device 100 specifies a post-movement pair that is a combination of a post-movement container 1901=container A and a post-movement Pod 1902=Pod A that corresponds to the specified pre-movement pair. The generation device 100 specifies the post-movement pair corresponding to the pre-movement pair based on the property information of the container before and after movement of the container, for example.

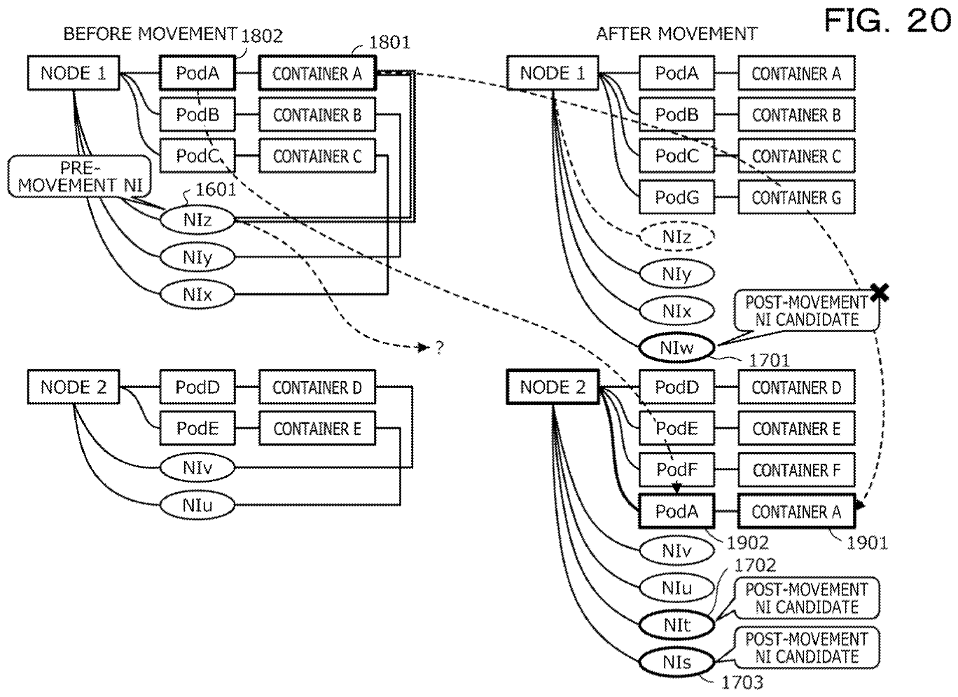

For example, the generation device 100 specifies the post-movement container 1901=container A that corresponds to other property information whose value of Name field matches with that of property information of the pre-movement container of the pre-movement pair. Next, for example, the generation device 100 specifies the post-movement Pod 1902=Pod A including the post-movement container 1901=container A based on the property information of the post-movement container 1901=container A. Then, for example, the generation device 100 specifies the post-movement pair that is the combination of the post-movement container 1901=container A and the post-movement Pod 1902=Pod A. Thus, the generation device 100 may obtain information to be a due to specify the post-movement NI. Next, description of FIG. 20 will be made.

In FIG. 20, the generation device 100 specifies the post-movement node=node 2 in which the specified post-movement pair exists. Then, the generation device 100 extracts post-movement NI candidates 1702, 1703=NIt, NIs existing in the specified post-movement node=node 2 among the specified post-movement NI candidates 1701 to 1703=NIw, NIt, NIs.

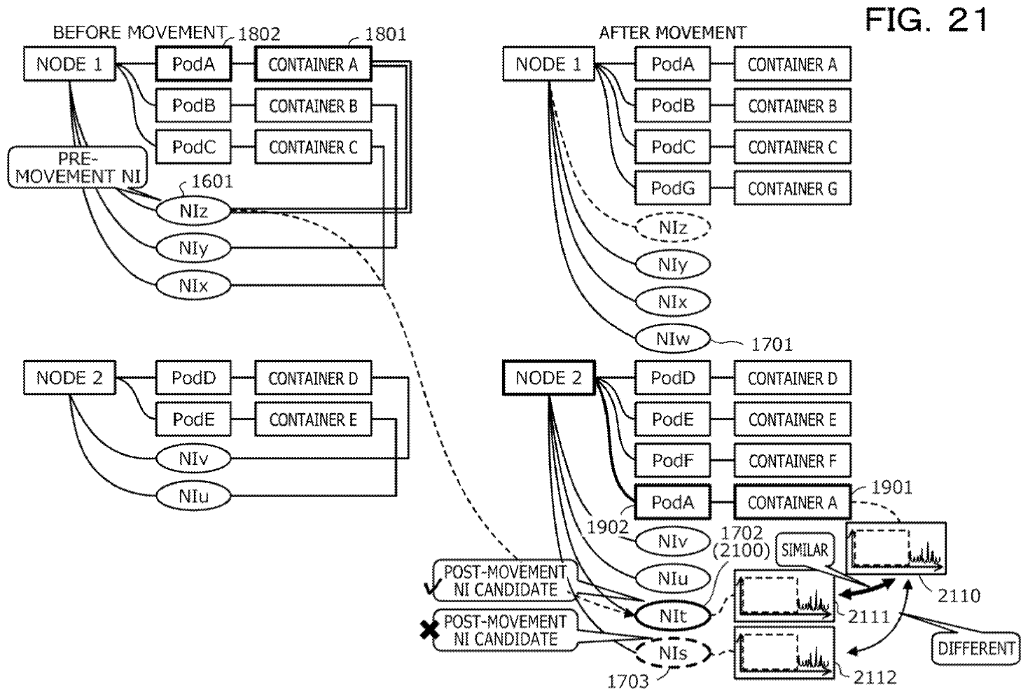

The generation device 100 specifies, for example, the post-movement node=node 2 in which the post-movement pair exists, based on the property information of the post-movement container 1901=container A. Then, the generation device 100 selects, for example, the post-movement NI candidates 1702, 1703=NIt, NIs existing in the specified post-movement node=node 2 among the specified post-movement NI candidates 1701 to 1703=NIw, NIt, NIs. Thus, the generation device 100 may exclude post-movement NI candidates that are not preferable to be associated with the pre-movement NI among the identified post-movement NI candidates. Thus, the generation device 100 may improve accuracy of specifying the post-movement NI, and may reduce the amount of processing needed when specifying the post-movement NI. Next, description of FIG. 21 will be made.

In FIG. 21, the generation device 100 specifies a post-movement NI 2100=NIt associated with the pre-movement NI 1601=NIz from the extracted post-movement NI candidates 1702, 1703=NIt, NIs. The generation device 100 analyzes, for example, features represented by metrics information 2110 of the post-movement container 1901=container A and features represented by extracted metrics information 2111, 2112 of the post-movement NI candidates 1702, 1703=NIt, NIs. The features are represented by, for example, the distribution at a time point when the performance value increases by a certain amount or more.

Next, the generation device 100 calculates similarity between, for example, the analyzed features represented by the metrics information 2111, 2112 of the post-movement NI candidates 1702, 1703=NIt, NIs, and the features represented by the metrics information 2110 of the post-movement container 1901=container A. Then, the generation device 100 specifies, for example, the post-movement NI 2100=NIt having the largest calculated similarity among the post-movement NI candidates 1702, 1703=NIt, NIs.

Thereafter, the generation device 100 generates the post-combination metrics information by combining the metrics information of the pre-movement NI 1601=NIz and the metrics information of the post-movement NI 2100=NIt. The generation device 100 outputs the generated post-combination metrics information. The generation device 100 may, for example, display the post-combination metrics information in a graph so that the user can refer to it.

Thus, the generation device 100 may associate the metrics information of different NIs regarding the same container, which was once disconnected due to the movement of the container. Even if there are multiple containers that are moved, started, or deleted in the same period, the generation device 100 may associate the metrics information of the pre-movement NI with the metrics information of the post-movement NI.

At this time, the generation device 100 may avoid collecting container-NI connection information indicating the connection relationship between the container and NI from each node every time the container is moved, and may suppress increase in processing load on each node. Furthermore, the generation device 100 may suppress increase in network traffic due to communication with each node.

Thus, the generation device 100 may facilitate use of the metrics information of different NIs that have been used by the container before and after movement. The generation device 100 may facilitate acquisition of, for example, a set value such as a threshold associated with the metrics information of the pre-movement NI, which has been used when monitoring the metrics information of the pre-movement NI. Then, for example, the generation device 100 may divert the acquired set value upon monitoring the metrics information of post-movement NI, and may facilitate appropriate monitoring.

Furthermore, for example, upon predicting changes in future performance value of the post-movement NI, the generation device 100 may refer to the metrics information of the post-movement NI as well as the metrics information of the pre-movement NI. Thus, the generation device 100 may suppress decrease in accuracy of predicting changes in future performance value of the post-movement NI. Furthermore, the generation device 100 may allow the user to refer to the metrics information of the pre-movement NI and the metrics information of the post-movement NI.

(Overall Processing Procedure in Operation Example 1)

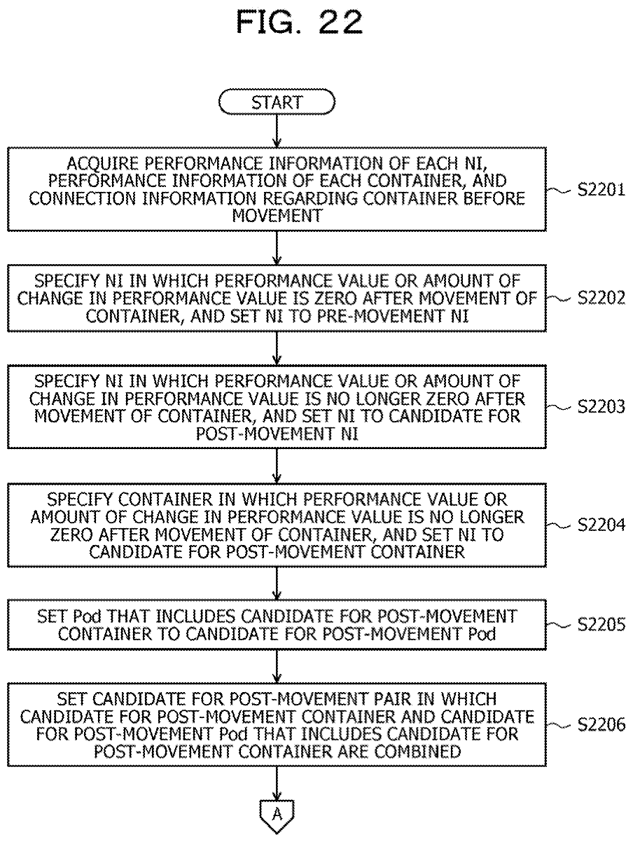

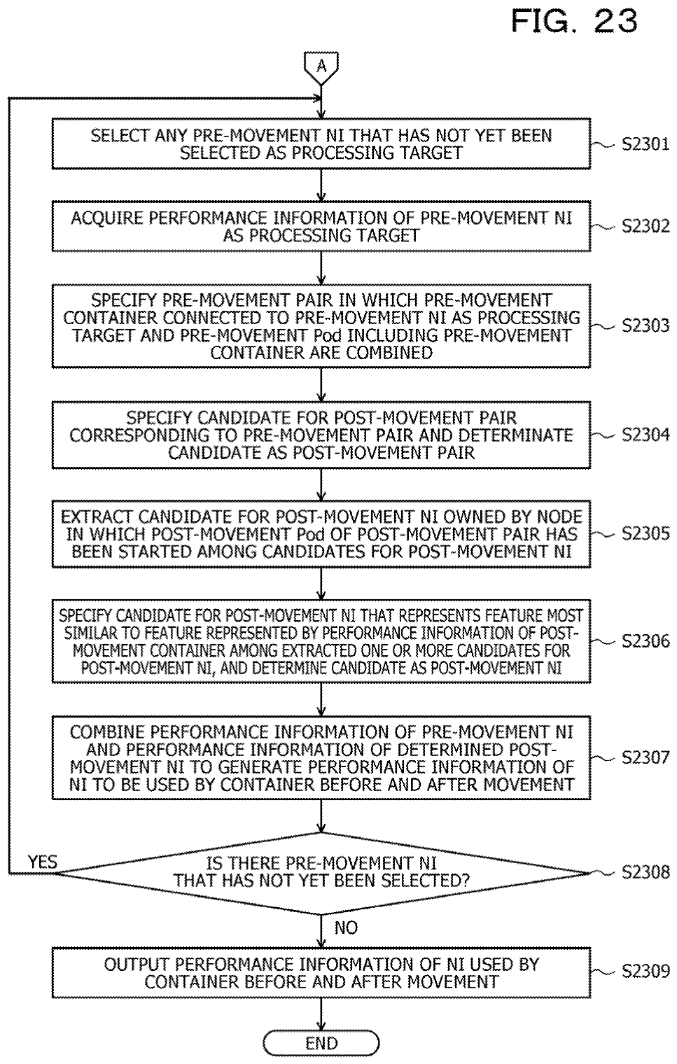

Next, an example of an overall processing procedure executed by the generation device 100 in operation example 1 will be described with reference to FIGS. 22 and 23. The overall processing is implemented by, for example, the CPU 301, the storage area of the memory 302, the recording medium 305, or the like, and the network I/F 303 illustrated in FIG. 3.

FIGS. 22 and 23 are flowcharts illustrating an example of the overall processing procedure according to operation example 1. In FIG. 22, the generation device 100 acquires the performance information of each NI, the performance information of each container, and the connection information regarding the container before being moved (step S2201).

Next, the generation device 100 specifies NI in which the performance value or the amount of change in the performance value is zero after movement of the container in the time series of performance values indicated by the performance information based on the performance information of each NI, and sets the NI to the pre-movement NI (step S2202). Then, the generation device 100 specifies NI in which the performance value or the amount of change in the performance value is no longer zero after movement of the container in the time series of the performance values indicated by the performance information based on the performance information of each NI, and sets the NI to a candidate for the post-movement NI (step S2203).

Next, the generation device 100 specifies a container in which the performance value or the amount of change in the performance value is no longer zero after movement of the container in the time series of the performance values indicated by the performance information based on the performance information of each container, and sets the container to a candidate for the post-movement container (step S2204). Then, the generation device 100 sets a Pod including the set candidate for the post-movement container to a candidate for the post-movement Pod (step S2205).

Next, the generation device 100 sets a candidate for the post-movement pair, in which the set candidate for the post-movement container and the set candidate for the post-movement Pod including the set candidate for the post-movement container are combined (step S2206). Then, the generation device 100 shifts to the processing of step S2301 of FIG. 23.

In FIG. 23, the generation device 100 selects any NI that has not yet been selected among the set one or more pre-movement NIs as a processing target (step S2301).

Next, the generation device 100 acquires the performance information of the pre-movement NI as the selected processing target (step S2302). Then, the generation device 100 specifies a pre-movement pair in which the pre-movement container that is connected to the pre-movement NI as the selected processing target and the pre-movement Pod including the pre-movement container are combined based on the acquired connection information regarding the container before being moved (step S2303).

Next, the generation device 100 compares the property of the pre-movement pair with the property of each candidate for the post-movement pair of one or more set candidates for the post-movement pair, specifies a candidate for the post-movement pair corresponding to the pre-movement pair, and determines the candidate as the post-movement pair (step S2304). Then, the generation device 100 extracts a candidate for the post-movement NI owned by the node in which the post-movement Pod of the post-movement pair has been started among the set candidates for the post-movement NI (step S2305).

Next, the generation device 100 specifies the candidate for the post-movement NI that represents a feature most similar to a feature represented by the performance information of the post-movement container among the extracted one or more candidates for the post-movement NI, and determines the candidate as the post-movement NI (step S2306). Then, the generation device 100 combines the performance information of the pre-movement NI and the performance information of the determined post-movement NI to generate the performance information of NI to be used by the container before and after movement (step S2307).

Next, the generation device 100 determines whether or not there is a pre-movement NI that has not yet been selected among the set one or more pre-movement NIs (step S2308). Here, when a pre-movement NI that has not yet been selected remains (step S2308: Yes), the generation device 100 returns to the processing of step S2301. On the other hand, when all the pre-movement NIs have been selected (step S2308: No), the generation device 100 shifts to the processing of step S2309.

In step S2309, the generation device 100 outputs the performance information of NI used by the container before and after movement after the combination (step S2309). Then, the generation device 100 ends the overall processing. Thus, the generation device 100 may associate the performance information of the pre-movement NI with the performance information of the post-movement NI.

Here, the generation device 100 may execute the processing of some steps in each of the flowcharts of FIGS. 22 and 23 in a different order. For example, the processing order of steps S2202, S2203 may be exchanged. Furthermore, the generation device 100 may omit the processing of some steps in each of the flowcharts of FIGS. 22 and 23.

(Operation Example 2 of Generation Device 100)

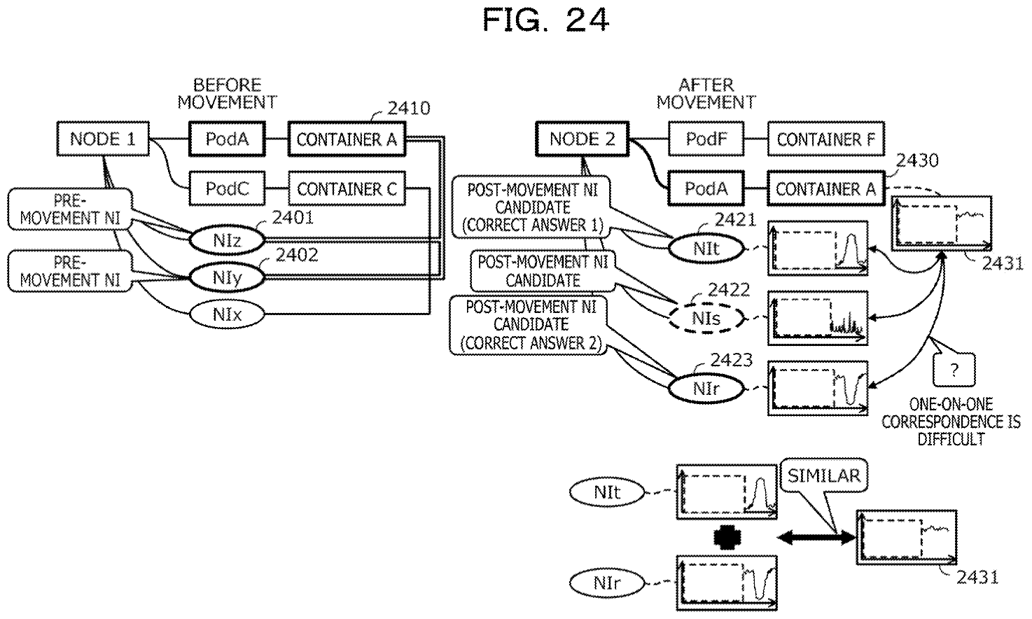

Next, operation example 2 of the generation device 100 will be described with reference to FIGS. 24 to 27.

FIGS. 24 to 27 are explanatory views illustrating operation example 2 of the generation device 100. In the above-mentioned operation example 1, the case where the pre-movement NI that has been used by the pre-movement container is one has been described, but the present embodiment is not limited to this. For example, there may be multiple pre-movement NIs used by the pre-movement container. The operation example 2 is an example corresponding to a case where the generation device 100 has multiple pre-movement NIs used by the pre-movement container.

In FIG. 24, it is assumed that a container A is moved from a node 1 to a node 2. Before movement, the container A has been using NIy and NIz owned by the node 1. After movement, the container A uses NIt and NIr owned by the node 2.

At this time, it is difficult associate the features represented by the metrics information of the container A and the features represented by the metrics information of NIt, NIs, and NIr owned by the node 2 on a one-to-one basis. For example, the features represented by the metrics information of the container A tend to appear dispersedly among the features represented by the metrics information of NIt, NIs, and NIr owned by the node 2. Thus, it is difficult to associate the features represented by the metrics information of the container A and the features represented by the metrics information of NIt, NIs, and NIr owned by the node 2 on a one-to-one basis.

On the other hand, the generation device 100 specifies pre-movement NIs 2401, 2402=NIz, NIy, and specifies a pre-movement container 2410=container A corresponding to the pre-movement NIs 2401, 2402=NIz, NIy. Thereafter, the generation device 100 calculates the number of pre-movement NIs 2401, 2402 used by the pre-movement container 2410=container A=2.

Furthermore, the generation device 100 specifies post-movement NI candidates 2421 to 2423=NIt, NIs, NIr. Next, the generation device 100 specifies a plurality of post-movement NI candidate combinations obtained by combining the calculated number=2 of post-movement NI candidates among the specified post-movement NI candidates 2421 to 2423=NIt, NIs, NIr. Then, the generation device 100 generates post-synthesis metrics information by synthesizing the metrics information of the post-movement NI candidates included in each post-movement NI candidate combination.

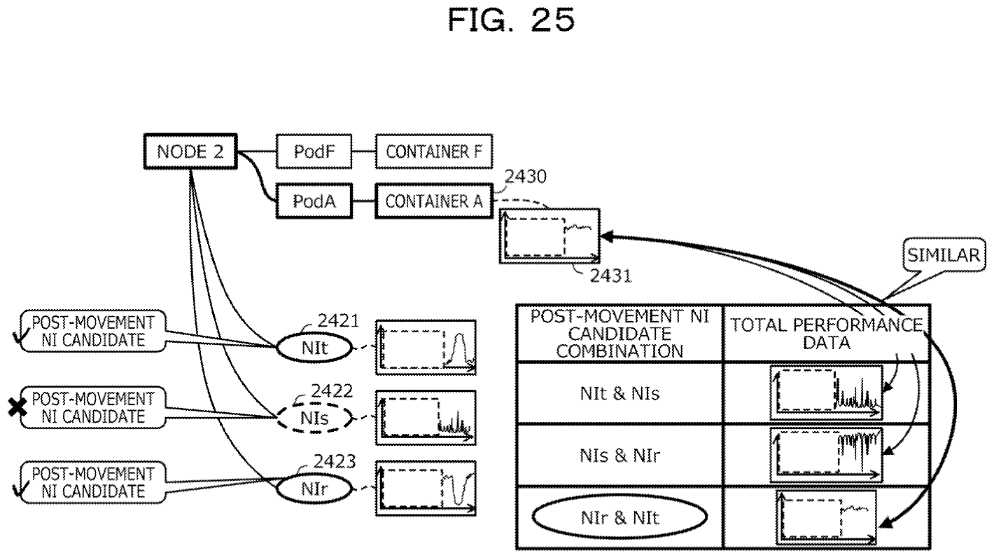

The generation device 100 specifies the post-movement NI candidate combination corresponding to a post-movement container 2430 by comparing the generated post-synthesis metrics information with metrics information 2431 of the post-movement container 2430. The generation device 100 specifies, for example, the post-movement NI candidate combination corresponding to the post-synthesis metrics information representing a feature similar to a feature represented by the metrics information 2431 of the post-movement container 2430 among the plurality of post-movement NI candidate combinations. Next, description of FIG. 25 will be made, and a specific example in which the generation device 100 specifies the post-movement NI candidate combination corresponding to the post-movement container 2430 will be described.

In FIG. 25, the generation device 100 generates post-movement NI candidate combinations=NIt & NIs, NIs & NIr, NIr & NIt. The generation device 100 synthesizes the metrics information of two different NIs included in each of the post-movement NI candidate combinations=NIt & NIs, NIs & NIr, NIr & NIt, and generates post-synthesis metrics information. Synthesis is, for example, addition of performance values.

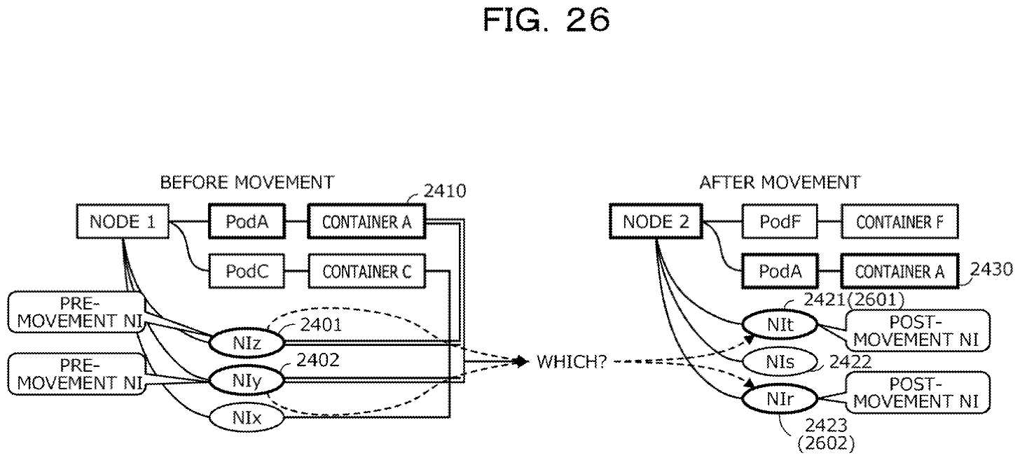

The generation device 100 calculates the similarity between the features of the metrics information 2431 of the post-movement container 2430 and the features of the post-synthesis metrics information corresponding to each of the post-movement NI candidate combinations=NIt & NIs, NIs & NIr, NIr & NIt. The generation device 100 specifies the post-movement NI candidate combination=NIr & NIt that has the largest calculated similarity. Next, description of FIG. 26 will be made.

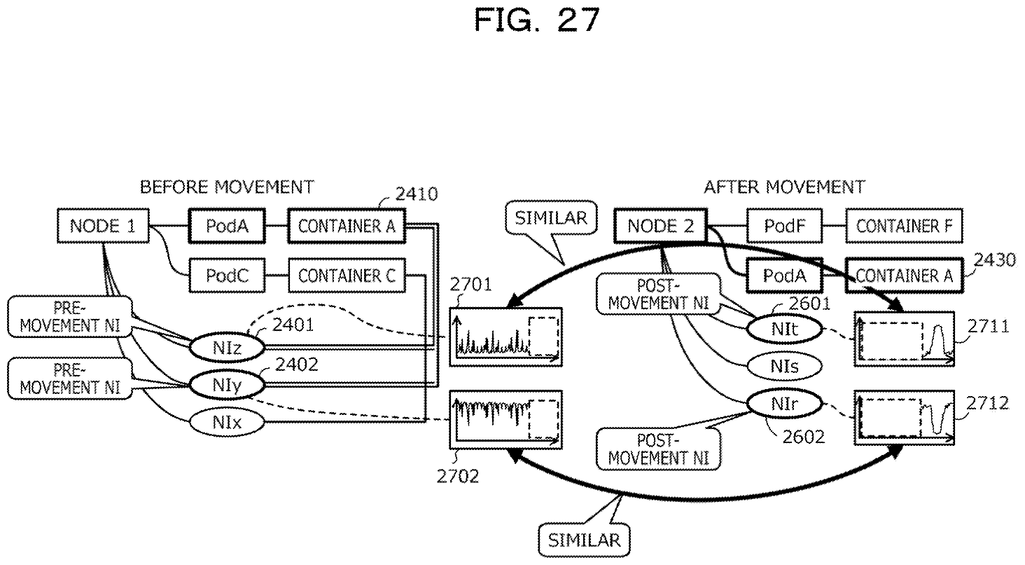

In FIG. 26, the generation device 100 specifies post-movement NIs 2601, 2602=NIt, NIr from the post-movement NI candidate combination=NIr & NIt corresponding to the post-movement container 2430. The generation device 100 associates the pre-movement NIs 2401, 2402=NIz, NIy with the post-movement NIs 2601, 2602=NIt, NIr on a one-to-one basis. Next, description of FIG. 27 will be made, and a specific example in which the generation device 100 associates the pre-movement NI with the post-movement NI on a one-to-one basis will be described.

In FIG. 27, the generation device 100 compares metrics information 2701, 2702 of the pre-movement NIs 2401, 2402=NIz, NIy before movement with metrics information 2711, 2712 of the post-movement NIs NI 2601, 2602=NIt, NIr after movement. Based on a comparison result, the generation device 100 associates the pre-movement NIs 2401, 2402=NIz, NIy with the post-movement NIs 2601, 2602=NIt, NIr on a one-to-one basis. The generation device 100 associates the pre-movement NI with the post-movement NI, for example, corresponding to different metrics information with similar features. The feature is represented by, for example, a range from the maximum value to the minimum value of the performance value.

For example, the generation device 100 calculates the degree of overlap as the degree of similarity between the range from the maximum value to the minimum value of the performance values of respective pieces of the metrics information 2701, 2702 and the range from the maximum value to the minimum value of the performance values of respective pieces of the metrics information 2711, 2712. Then, for example, the generation device 100 associates the combination of the pre-movement NI and the post-movement NI, which corresponds to the combination of the metrics information having the largest similarity.

In the example of FIG. 27, the generation device 100 associates the pre-movement NI 2401=NIz with the post-movement NI 2601=NIt on a one-to-one basis. The generation device 100 combines the metrics information of the pre-movement NI 2401=NIz and the metrics information of the post-movement NI 2601=NIt to generate post-combination metrics information. Furthermore, the generation device 100 associates the pre-movement NI 2402=NIy with the post-movement NI 2602=NIr on a one-to-one basis. The generation device 100 combines the metrics information of the pre-movement NI 2402=NIy and the metrics information of the post-movement NI 2602=NIr to generate post-combination metrics information.

Thus, even if there is a plurality of NIs used by the container before being moved, the generation device 100 may associate the metrics information of different NIs regarding the same container once disconnected due to movement of the container. Therefore, the generation device 100 may facilitate use of the metrics information of different NIs that have been used by the container before and after movement.

(Overall Processing Procedure in Operation Example 2)

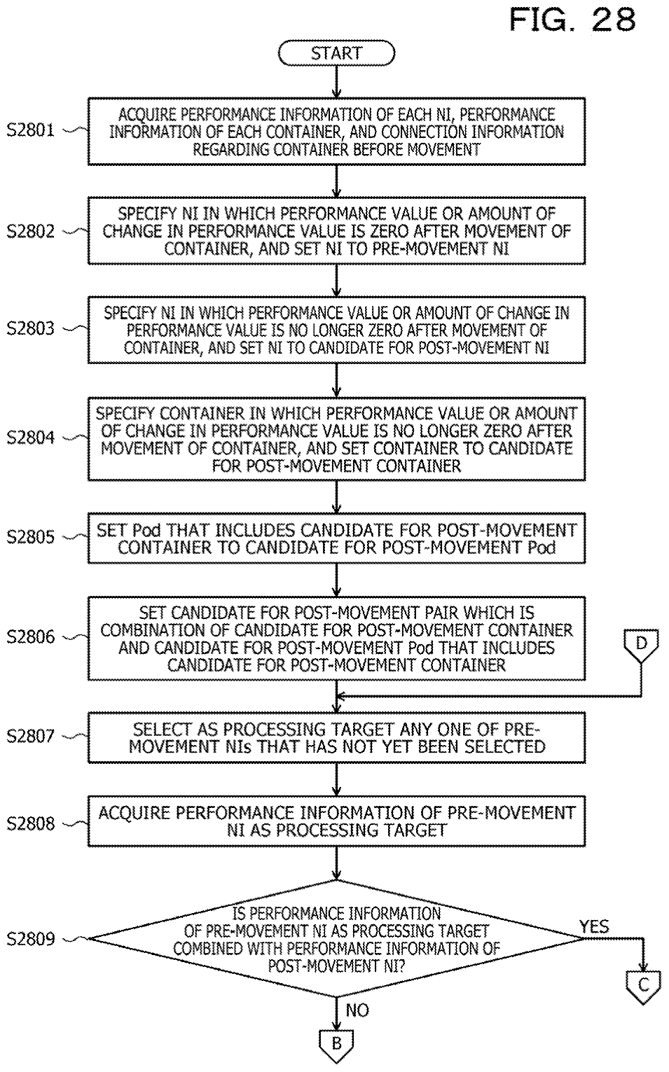

Next, an example of an overall processing procedure executed by the generation device 100 in operation example 2 will be described with reference to FIGS. 28 to 30. The overall processing is implemented by, for example, the CPU 301, the storage area of the memory 302, the recording medium 305, or the like, and the network I/F 303 illustrated in FIG. 3.

FIGS. 28 to 30 are flowcharts illustrating an example of the overall processing procedure according to operation example 2. In FIG. 28, the generation device 100 acquires the performance information of each NI, the performance information of each container, and the connection information regarding the container before being moved (step S2801).

Next, the generation device 100 specifies NI in which the performance value or the amount of change in the performance value is zero after movement of the container in the time series of the performance values indicated by the performance information based on the performance information of each NI, and sets the NI to the pre-movement NI (step S2802). Then, the generation device 100 specifies NI in which the performance value or the amount of change in the performance value is no longer zero after movement of the container in the time series of the performance values indicated by the performance information based on the performance information of each NI, and sets the NI to a candidate for the post-movement NI (step S2803).

Next, the generation device 100 specifies a container in which the performance value or the amount of change in the performance value is not zero after the container is moved in the time series of the performance values indicated by the performance information based on the performance information of each container, and sets the container to a candidate for the post-movement container (step S2804). Then, the generation device 100 sets a Pod including the set candidate for the post-movement container to a candidate for the post-movement Pod (step S2805).

Next, the generation device 100 sets a candidate for the post-movement pair, which is a combination of the set candidate for the post-movement container and the set candidate for the post-movement Pod including the set candidate for the post-movement container (step S2806). Then, the generation device 100 selects any NI that has not yet been selected among the set one or more pre-movement NIs as a processing target (step S2807).

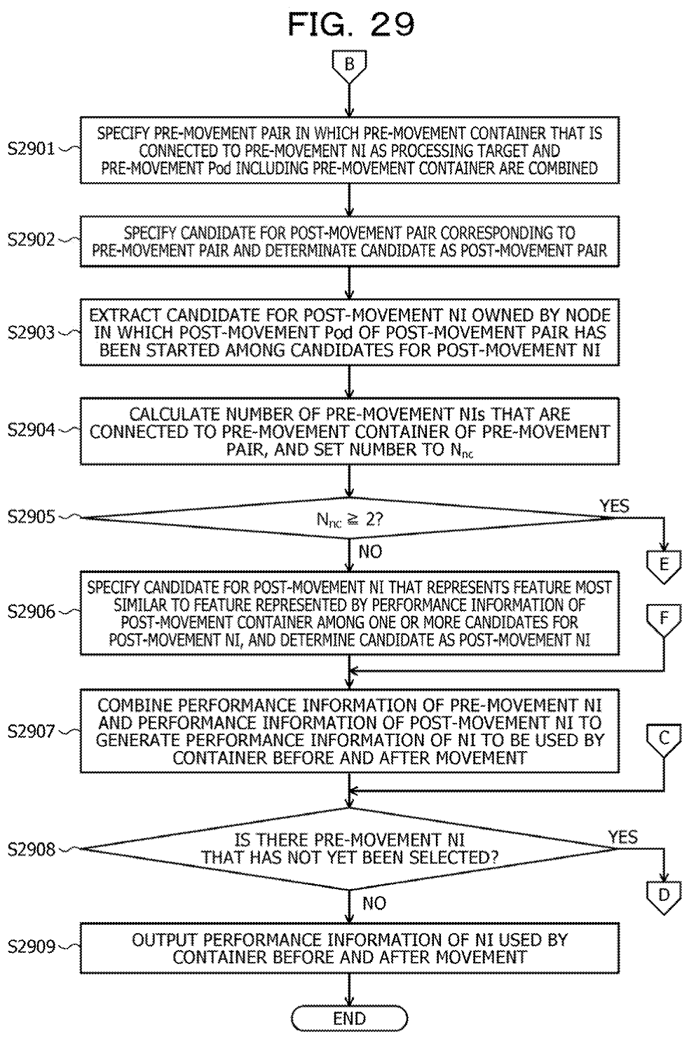

Next, the generation device 100 acquires the performance information of the pre-movement NI as the selected processing target (step S2808). Then, the generation device 100 determines whether or not the performance information of the selected pre-movement NI as the processing target has been combined with the performance information of the post-movement NI (step S2809). Here, when they have been combined (step S2809: Yes), the generation device 100 shifts to the processing of step S2908 of FIG. 29. On the other hand, when they have not been combined (step S2809: No), the generation device 100 shifts to the processing of step S2901 of FIG. 29.

In FIG. 29, the generation device 100 specifies a pre-movement pair in which the pre-movement container that is connected to the pre-movement NI as the selected processing target and the pre-movement Pod Including the pre-movement container are combined based on the acquired connection information regarding the container before being moved (step S2901).

Next, the generation device 100 compares the property of the pre-movement pair with the property of each candidate for the post-movement pair out of one or more set candidates for the post-movement pair, specifies a candidate for the post-movement pair corresponding to the pre-movement pair, and determines the candidate as the post-movement pair (step S2902). Then, the generation device 100 extracts a candidate for the post-movement NI owned by the node in which the post-movement Pod of the post-movement pair has been started among the set candidates for the post-movement NI (step S2903).

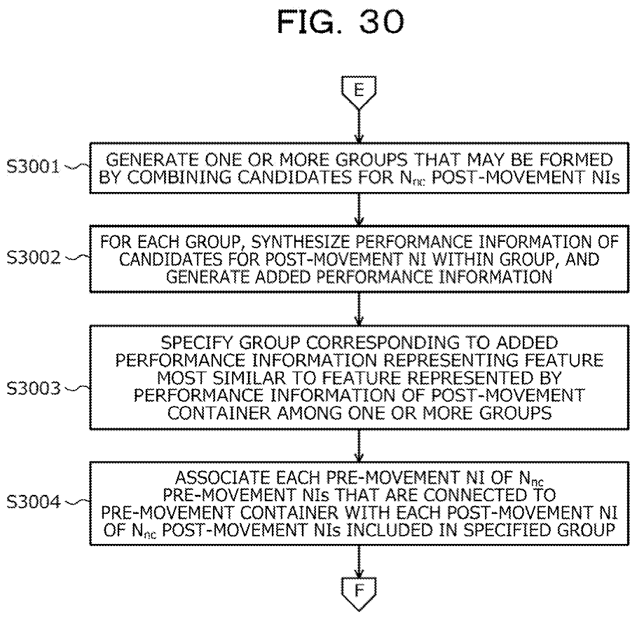

Next, the generation device 100 calculates the number of pre-movement NIs that is connected to the pre-movement container of the specified pre-movement pair and sets the number to N_{nc} (step S2904). Then, the generation device 100 determines whether or not N_{nc}≥2 (step S2905). Here, when N_{nc}≥2 (step S2905: Yes), the generation device 100 shifts to the processing of step S3001 of FIG. 30. On the other hand, when N_{nc}=1 (step S2905: No), the generation device 100 shifts to the processing of step S2906.

In step S2906, the generation device 100 specifies the candidate for the post-movement NI that represents a feature most similar to a feature represented by the performance information of the post-movement container among the extracted one or more candidates for the post-movement NI, and determines the candidate as the post-movement NI (step S2906).

Next, the generation device 100 combines the performance information of the pre-movement NI and the performance information of the determined post-movement NI to generate the performance information of NI to be used by the container before and after movement (step S2907). Then, the generation device 100 determines whether or not there is a pre-movement NI that has not yet been selected among the set one or more pre-movement NIs (step S2908).

Here, when a pre-movement NI that has not yet been selected remains (step S2908: Yes), the generation device 100 returns to the processing of step S2807 of FIG. 28. On the other hand, when all the pre-movement NIs have been selected (step S2908: No), the generation device 100 shifts to the processing of step S2909.

In step S2909, the generation device 100 outputs the performance information of NI used before and after the container moves after the combination (step S2909). Then, the generation device 100 ends the overall processing. Thus, the generation device 100 may associate the performance information of the pre-movement NI with the performance information of the post-movement NI. Here, description of FIG. 30 will be made.

In FIG. 30, the generation device 100 generates one or more groups that may be formed by combining candidates for the N_{nc} post-movement NIs (step S3001).

Next, for each group, the generation device 100 synthesizes the performance information of candidates for the post-movement NI within the group, and generates added performance information (step S3002). Then, the generation device 100 specifies a group corresponding to the added performance information representing a feature most similar to a feature represented by the performance information of the post-movement container among the one or more groups (step S3003).

Next, the generation device 100 associates each pre-movement NI of the N_{nc} pre-movement NIs that are connected to the pre-movement container with each post-movement NI of the N_{nc} post-movement NIs Included in the specified group (Step S3004). Then, the generation device 100 shifts to the processing of step S2907 of FIG. 29. Thus, the generation device 100 may handle cases where multiple pre-movement NIs exist.

Here, the generation device 100 may execute the processing of some steps in each of the flowcharts of FIGS. 28 to 30 in a different order. For example, the processing order of steps S2802, S2803 may be exchanged. Furthermore, the generation device 100 may omit the processing of some steps in each of the flowcharts of FIGS. 28 to 30.

As described above, with the generation device 100, it is possible to acquire performance information of a container, which has been implemented in the first node and has been using the first NI owned by the first node, after the container is moved to a second node different from the first node. With the generation device 100, it is possible to specify the performance information of the second NI representing a feature similar to a feature represented by the acquired performance information of the container after being moved among the performance information of NI owned by the second node. With the generation device 100, it is possible to generate correspondence information that associates the performance information of the first NI with the specified performance information of the second NI. Thus, the generation device 100 may facilitate association and use of performance information of different NI regarding the same container that has been disconnected.

With the generation device 100, combined information obtained by combining a time series of performance values represented by the specified performance information of the second NI to a rear of a time series of performance values represented by the performance information of the first NI may be generated. Thus, the generation device 100 may facilitate integration and use of performance information of different NI regarding the same container.

With the generation device 100, among a plurality of NIs owned by different nodes, NI having performance information representing that a performance value or the amount of change in the performance value becomes zero before or after a certain time point may be set as the first NI. With the generation device 100, it is possible to acquire the performance information of the container, which has been implemented in the first node having the set first NI and has been using the first NI owned by the first node, after the container is moved to a second node. Thus, the generation device 100 sets the NI that has been used by the container before being moved to the first NI, and may facilitate association of the performance information of different NIs related to the same container.

With the generation device 100, it is possible to extract, from the performance information of the NI owned by the second node, performance information representing that a performance value or an amount of change in the performance value is no longer zero before or after a certain time point. With the generation device 100, it is possible to specify the performance information of the second NI, which represents a feature similar to a feature represented by the acquired performance information of the container after being moved, among the extracted performance information. Thus, the generation device 100 may facilitate specification of a candidate for NI being used by the container after being moved, and may easily associate different performance information of NI regarding the same container. Furthermore, the generation device 100 may reduce the processing amount.

With the generation device 100, the container before being moved to the second node may be specified based on information that makes it possible to specify NI used by each container of a plurality of containers before a certain time point. With the generation device 100, the container after being moved may be specified, which corresponds to the specified container before being moved and is implemented in the second node, based on attribute information of each container before or after the certain time point. With the generation device 100, it is possible to acquire the performance information of the specified container after being moved. Thus, the generation device 100 may facilitate specification of the container after being moved and association of performance information of different NIs regarding the same container.

With the generation device 100, it is possible to measure the number of NIs that have been used by the container before being moved among the NIs owned by the first node. With the generation device 100, for every combination of performance information for the measured number of NI owned by the second node, it is possible to generate synthetic information obtained by synthesizing the combination. With the generation device 100, it is possible to specify, among the generated synthetic information, the performance information of the second NI included in a combination as a synthesis source of any of the synthetic information representing a feature similar to a feature represented by the acquired performance information of the container after being moved. Thus, the generation device 100 may facilitate association of the performance information of different NIs regarding the same container even when there is a plurality of NIs owned by the first node.

With the generation device 100, it is possible to specify any of synthetic information representing a feature similar to a feature represented by the acquired performance information of the container after being moved among the generated synthetic information. With the generation device 100, it is possible to specify the performance information of the second NI, which is included in a combination as a synthesis source of specified synthetic information and represents a feature similar to a feature represented by the performance information of the first NI, may be specified. Thus, the generation device 100 may facilitate association of the performance information of different NIs regarding the same container even when there is a plurality of NIs owned by the first node.

With the generation device 100, it is possible to acquire performance information of a container, which has been implemented in the first node and has been using a first NI owned by the first node, after the container is deleted in the first node and regenerated again. With the generation device 100, it is possible to specify performance information of a second NI, which represents a feature similar to a feature represented by the acquired performance information of the container after being generated, among the performance information of NI owned by the first node. With the generation device 100, it is possible to generate correspondence information that associates performance information of the first NI with the specified performance information of the second NI. Thus, the generation device 100 may facilitate association of performance information of different NIs regarding the same container.

With the generation device 100, it is possible to generate correspondence information that associates the performance information of the first NI with the performance information of the specified second NI in association with identification information that identifies the container after being moved. Thus, the generation device 100 may specify the container after being moved.

With the generation device 100, the generated correspondence information may be output. Thus, the generation device 100 may make it possible for the user to refer to performance information of different NIs regarding the same container.

With the generation device 100, it is possible to generate correspondence information in which the first identification information that identifies the first NI and the second identification information that identifies the second NI are associated with each other. Thus, the generation device 100 may generate correspondence information that indirectly associates performance information of different NIs regarding the same container.

Note that the generation method described in the present embodiment may be implemented by executing a prepared program on a computer such as a personal computer (PC) or a workstation. The generation program described in the present embodiment is executed by being recorded on a computer-readable recording medium and being read from the recording medium by the computer. The recording medium is a hard disk, a flexible disk, a compact disc (CD)-ROM, a magneto-optical disc (MO), a digital versatile disc (DVD), or the like. Furthermore, the generation program described in the present embodiment may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A generation method for a computer to execute a process comprising:
acquiring performance information of a container, which has been implemented in a first node and has been using a first network interface owned by the first node, after the container is moved to a second node different from the first node;
specifying performance information of a second network interface, which represents a feature similar to a feature represented by the acquired performance information of the container after being moved, among performance information of a network interface owned by the second node; and
generating correspondence information that associates performance information of the first network interface with the specified performance information of the second network interface.

2. The generation method according to claim 1,
wherein the generating includes generating combined information by combining a time series of performance values represented by the specified performance information of the second network interface to a rear of a time series of performance values represented by the performance information of the first network interface.

3. The generation method according to claim 1, further comprising
setting, among a plurality of network interfaces owned by different nodes, a network interface that has performance information that represents that a performance value or an amount of change in the performance value has become zero before or after a certain time point, as the first network interface,
wherein the acquiring includes acquiring the performance information of the container, which has been implemented in the first node that has the set first network interface and has been using the first network interface owned by the first node, after the container is moved to the second node.

4. The generation method according to claim 1, further comprising
extracting, from the performance information of the network interface owned by the second node, performance information that represents that a performance value or an amount of change in the performance value is no longer zero before or after a certain time point,
wherein the specifying includes specifying the performance information of the second network interface, which represents a feature similar to a feature represented by the acquired performance information of the container after being moved, among the extracted performance information.

5. The generation method according to claim 1, further comprising:
specifying the container, which has been implemented in the first node, has been using the first network interface, and is before being moved to the second node, based on information to specify a network interface used by each container of a plurality of containers before a certain time point, and
specifying the container after being moved, which corresponds to the specified container before being moved and is implemented in the second node, based on attribute information of the each container before the certain time point and attribute information of the each container after the certain time point,
wherein the acquiring includes acquiring the performance information of the specified container after being moved.

6. The generation method according to claim 1, further comprising:
measuring, among the network interfaces owned by the first node, the number of network interfaces that have been used by the container before being moved, and
generating, for every combination of performance information for the measured number of network interfaces owned by the second node, synthetic information obtained by synthesizing the combination of performance information,
wherein the specifying includes specifying, among the generated synthetic information, the performance information of the second network interface included in a combination as a synthesis source of any of the synthetic information that represents a feature similar to a feature represented by the acquired performance information of the container after being moved.

7. The generation method according to claim 6, wherein
the specifying includes specifying the performance information of the second network interface, which is included in a combination as a synthesis source of any of synthetic information that represents a feature similar to a feature represented by the acquired performance information of the container after being moved among the generated synthetic information, and represents a feature similar to a feature represented by the performance information of the first network interface.

8. The generation method according to claim 1, further comprising:
acquiring performance information of a container, which has been implemented in the first node and has been using a first network interface owned by the first node, after the container is deleted in the first node and regenerated again,
specifying performance information of a second network interface, which represents a feature similar to a feature represented by the acquired performance information of the container after being generated, among performance information of a network interface owned by the first node, and
generating correspondence information that associates performance information of the first network interface with the specified performance information of the second network interface.

9. The generation method according to claim 1, wherein
the generating includes generating correspondence information that associates the performance information of the first network interface with the performance information of the specified second network interface in association with identification information that identifies the container after being moved.

10. The generation method according to claim 1, further comprising
outputting the generated correspondence information.

11. The generation method according to claim 8,
wherein the correspondence information is information in which first identification information that identifies the first network interface and second identification information that identifies second network interface are associated with each other.

12. A non-transitory computer-readable medium storing a program that causes at least one computer to execute a process, the process comprising:
acquiring performance information of a container, which has been implemented in a first node and has been using a first network interface owned by the first node, after the container is moved to a second node different from the first node;
specifying performance information of a second network interface, which represents a feature similar to a feature represented by the acquired performance information of the container after being moved, among performance information of a network interface owned by the second node; and
generating correspondence information that associates performance information of the first network interface with the specified performance information of the second network interface.

13. The non-transitory computer-readable medium according to claim 12, wherein the generating includes generating combined information by combining a time series of performance values represented by the specified performance information of the second network interface to a rear of a time series of performance values represented by the performance information of the first network interface.

14. The non-transitory computer-readable medium according to claim 12, wherein the process further comprising
setting, among a plurality of network interfaces owned by different nodes, a network interface that has performance information that represents that a performance value or an amount of change in the performance value has become zero before or after a certain time point, as the first network interface,
wherein the acquiring includes acquiring the performance information of the container, which has been implemented in the first node that has the set first network interface and has been using the first network interface owned by the first node, after the container is moved to the second node.

15. The non-transitory computer-readable medium according to claim 12, wherein the process further comprising extracting, from the performance information of the network interface owned by the second node, performance information that represents that a performance value or an amount of change in the performance value is no longer zero before or after a certain time point,
wherein the specifying includes specifying the performance information of the second network interface, which represents a feature similar to a feature represented by the acquired performance information of the container after being moved, among the extracted performance information.

16. The non-transitory computer-readable medium according to claim 12, wherein the process further comprising:
specifying the container, which has been implemented in the first node, has been using the first network interface, and is before being moved to the second node, based on information to specify a network interface used by each container of a plurality of containers before a certain time point, and
specifying the container after being moved, which corresponds to the specified container before being moved and is implemented in the second node, based on attribute information of the each container before the certain time point and attribute information of the each container after the certain time point,
wherein the acquiring includes acquiring the performance information of the specified container after being moved.

17. The non-transitory computer-readable medium according to claim 12, wherein the process further comprising
measuring, among the network interfaces owned by the first node, the number of network interfaces that have been used by the container before being moved, and
generating, for every combination of performance information for the measured number of network interfaces owned by the second node, synthetic information obtained by synthesizing the combination of performance information,
wherein the specifying includes specifying, among the generated synthetic information, the performance information of the second network interface included in a combination as a synthesis source of any of the synthetic information that represents a feature similar to a feature represented by the acquired performance information of the container after being moved.

18. The non-transitory computer-readable medium according to claim 17, wherein
the specifying includes specifying the performance information of the second network interface, which is included in a combination as a synthesis source of any of synthetic information that represents a feature similar to a feature represented by the acquired performance information of the container after being moved among the generated synthetic information, and represents a feature similar to a feature represented by the performance information of the first network interface.

19. The non-transitory computer-readable medium according to claim 18, wherein the process further comprising:
acquiring performance information of a container, which has been implemented in the first node and has been using a first network interface owned by the first node, after the container is deleted in the first node and regenerated again,
specifying performance information of a second network interface, which represents a feature similar to a feature represented by the acquired performance information of the container after being generated, among performance information of a network interface owned by the first node, and
generating correspondence information that associates performance information of the first network interface with the specified performance information of the second network interface.
